(19) United States
(12) Patent Application Publication
(10) Pub. No.: US 2017/0261734 A1
(43) Pub. Date: Sep. 14, 2017

(54) THERMAL EXPANSION ACTUATORS, MICROSCOPES INCLUDING THE SAME, AND RELATED METHODS

(71) Applicant: Tokitae LLC, BELLEVUE, WA (US)

(72) Inventors: Ryan Calderon, Seattle, WA (US); David Gasperino, Lake Forest Park, WA (US); Shawn Keith McGuire, Seattle, WA (US); James Andrew Roecker, Bellevue, WA (US)

(21) Appl. No.: 15/067,002

(22) Filed: Mar. 10, 2016

(51) Int. Cl. G02B 21/24; G02B 21/26

(52) U.S. Cl. CPC G02B 21/245; G02B 21/26

(57) ABSTRACT

Embodiments disclosed herein include thermal expansion actuators, systems using the same (e.g., microscopes), and methods of using the same. The thermal expansion actuators disclosed herein can include at least one beam coupled to and extending between a plurality of support portions. The thermal expansion actuators also include at least one heating element configured to heat at least a portion of the thermal expansion actuators, such as the at least one beam. The support portions are coupled to an structure (e.g., a component of a microscope) in a manner that at least partially restrains thermal expansion or contraction of the thermal expansion actuators in at least one direction when the thermal expansion actuators are heated or cooled, respectively. Restraining the thermal expansion actuators can controllably and selectively produce relative movement in the at least one beam (e.g., deflected). For example, the thermal expansion actuators can be heated or cooled to controllably and selectively deflect the beam in 1 μm displacements or less.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 U.S.C. §119(e) for provisional patent applications, for any and all parent, grandparent, great-grandparent, etc. applications of the Priority Application(s)).

### PRIORITY APPLICATIONS

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### BACKGROUND

Microscopy techniques are commonly used to diagnosis several diseases, hematology conditions, etc. Some microscopy techniques require specialized microscopes to achieve sufficient resolution for proper diagnosis.

Microscopes can be used to detect malaria using a thick malaria smear. Typically, the microscope includes an oil immersion lens having a relatively shallow depth of field to achieve the resolutions required to detect the parasitic protozoans that cause malaria. The lens typically exhibits a depth of field that is only a few micrometers, about a micrometer, or less than a micrometer. Typically, the entire thickness of the thick malaria smear is imaged to conclusively diagnose malaria. However, the thickness of the thick malaria smear is greater than a few micrometers. To ensure that the entire thick malaria smear is analyzed, the distance between the sample and the lens can be decreased or increased in 1 μm displacements or less and, more particularly, in 0.5 μm displacements or less, or in 0.3 μm displacements or less.

A typical microscope includes a conventional focusing system configured to increase or decrease a distance between the lens and the sample in micrometer displacements. However, such a conventional focusing system can be expensive and complex, which makes the conventional focusing systems unsuitable for areas where is malaria is most prevalent, such as in poverty stricken areas.

Therefore, developers and users of microscopes continue to seek improvements to microscopes for use in disease diagnosis.

### SUMMARY

Embodiments disclosed herein include thermal expansion actuators, systems using the same (e.g., microscopes), and methods of using the same. The thermal expansion actuators disclosed herein can include at least one beam coupled to and extending between a plurality of support portions. The thermal expansion actuators also include at least one heating element configured to heat at least a portion of the thermal expansion actuators, such as the at least one beam. The support portions are coupled to an structure (e.g., a component of a microscope) in a manner that at least partially restrains thermal expansion or contraction of the thermal expansion actuators in at least one direction when the thermal expansion actuators are heated or cooled, respectively. Restraining the thermal expansion actuators can controllably and selectively produce deflection of the at least one beam. For example, the thermal expansion actuators can be heated or cooled to controllably and selectively deflect the beam in 1 μm displacements or less.

In an embodiment, a thermal expansion actuator for producing relative movement between at least one lens and a stage of a microscope is disclosed. The thermal expansion actuator includes a plurality of support portions spaced from each other. The thermal expansion actuator further includes at least one beam generally defining a longitudinal axis and coupled to each of the plurality of support portions. At least a portion of the at least one beam is obliquely angled relative to the longitudinal axis. The at least one beam includes at least one slot extending at least partially therethrough. The thermal expansion actuator also includes at least one heating element positioned and configured to heat the at least one beam.

In an embodiment, a microscope is disclosed. The microscope includes a frame and a column coupled to the frame. The column includes at least one lens. The microscope further includes a stage coupled to the frame and positioned below the column. Additionally, the microscope includes a thermal expansion actuator operably coupled to the column or to the stage. The thermal expansion actuator is configured to selectively increase or decrease a distance between the at least one lens and the stage. The thermal expansion actuator includes a plurality of support portions spaced from each other. Each of the plurality of support portions is coupled to one of the frame, the column, or the stage. The thermal expansion actuator also includes at least one beam coupled to the plurality of support portions. The at least one beam is operably coupled to a different one of the frame, the column, or the stage than the plurality of support portions. The thermal expansion actuator also includes at least one heating element positioned and configured to controllably heat the at least one beam. The microscope further includes a controller including control electrical circuitry. The control electrical circuitry is operably coupled to the at least one heating element and configured to controllably direct the at least one heating element to heat the at least one beam.

In an embodiment, a method of using a microscope including a frame having a column coupled thereto and a stage coupled to the frame, with the column including at least one lens is disclosed. The method includes holding a sample on the stage of the microscope. The method also includes thermally actuating at least one beam of a thermal expansion actuator that is coupled to the frame and operably coupled to one of the stage or the column to selectively decrease or increase a distance between the stage and the at least one lens.

Features from any of the disclosed embodiments may be used in combination with one another, without limitation. In addition, other features and advantages of the present disclosure will become apparent to those of ordinary skill in the art through consideration of the following detailed description and the accompanying drawings.

The foregoing summary is illustrated only and is not intended to be in any way limiting. In addition to the illustrate aspects, embodiments, and features described above, further aspects, embodiments, and features will become apparent by reference to the drawings and the following detailed description.

### BRIEF DESCRIPTION OF THE FIGURES

FIGS. 1A-1C are isometric, side elevational, and top plan views, respectively, of a thermal expansion actuator, according to an embodiment.

FIG. 1D is a schematic cross-sectional view of a system configured to controllably or selectively heat the thermal expansion actuator shown in FIGS. 1A-1C, according to an embodiment.

FIG. 2 is a flow diagram of a method of using any of the systems disclosed herein, according to an embodiment.

FIGS. 3A and 3B are schematic cross-sectional views of thermal expansion actuators that include different heating elements, according to different embodiments.

FIG. 4 is a top plan view of a thermal expansion actuator including one or more slots formed therein, according to an embodiment.

FIGS. 5A and 5B are isometric views of thermal expansion actuators that include a receiving area spaced from at least one beam configured to have any heating elements disclosed herein positioned therein or thereon, according to different embodiments.

FIG. 6 is a schematic cross-sectional view of a thermal expansion actuator including a plurality of beams coupled to and extending between a plurality of support portions, according to an embodiment.

FIG. 7 is a schematic cross-sectional view of a thermal expansion actuator including a plurality of beams coupled to and extending between a plurality of support portions, according to an embodiment.

FIG. 8A is an isometric view of a microscope including a focusing system that includes any of the thermal expansion actuators disclosed herein, according to an embodiment.

FIGS. 8B-8D are isometric, cross-sectional, and enlarged cross-sectional views, respectively, of a connector including a focusing system that can be used in the microscope shown in FIG. 8A, according to an embodiment.

FIG. 8E is a schematic cross-sectional view of at least a portion of a stage that includes a focusing system that can be used in the microscope in FIG. 8A, according to an embodiment.

FIG. 9 is a flow diagram of a method of using any of the microscopes disclosed herein, according to an embodiment.

### DETAILED DESCRIPTION

Embodiments disclosed herein include thermal expansion actuators, systems using the same (e.g., microscopes), and methods of using the same. The thermal expansion actuators disclosed herein can include at least one beam coupled to and extending between a plurality of support portions. The thermal expansion actuators also include at least one heating element configured to heat at least a portion of the thermal expansion actuators, such as the at least one beam. The support portions are coupled to an structure (e.g., a component of a microscope) in a manner that at least partially restrains thermal expansion or contraction of the thermal expansion actuators in at least one direction when the thermal expansion actuators are heated or cooled, respectively. Restraining the thermal expansion actuators can controllably and selectively produce deflection of the at least one beam. For example, the thermal expansion actuators can be heated or cooled to controllably and selectively deflect the beam in 1 μm displacements or less.

In an embodiment, the thermal expansion actuators can be used in microscopes. For example, the thermal expansion actuators can be used in a focusing system of a microscope. The focusing systems can be used in microscopes including at least one lens (e.g., oil immersion lens) having a relatively shallow depth of field (e.g., a depth of field that is only a few micrometers, about a micrometer, or less than a micrometer). In an embodiment, such a microscope can detect malaria in a thick malaria smear. To image substantially the entire thickness of the thick malaria smear, the distance between the at least one lens and the thick malaria smear must be increased or decreased in 1 μm displacements or less, and more particularly in 0.5 μm displacements or less or 0.3 μm displacements or less. The thermal expansion actuators disclosed herein can be used to controllably and selectively increase or decrease the distance between the at least one lens and the sample in 1 μm displacements or less.

The thermal expansion actuators disclosed herein can also be used in microscopes configured to detect chagas disease, borrelia, microfilariae, or other diseases. The thermal expansion actuators disclosed herein can also be used in microscopes configured to detect one or more hematology conditions, such as low/high platelet count, differential white blood cell count, hemozoin in white blood cells, blast cells, sickle cells, nucleated red cells, etc.

Although the thermal expansion actuators disclosed herein are typically used in microscopes, it should be understood that the thermal expansion actuators can be used in any application requiring relatively fine displacement control (e.g., 1 μm displacements or less).

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

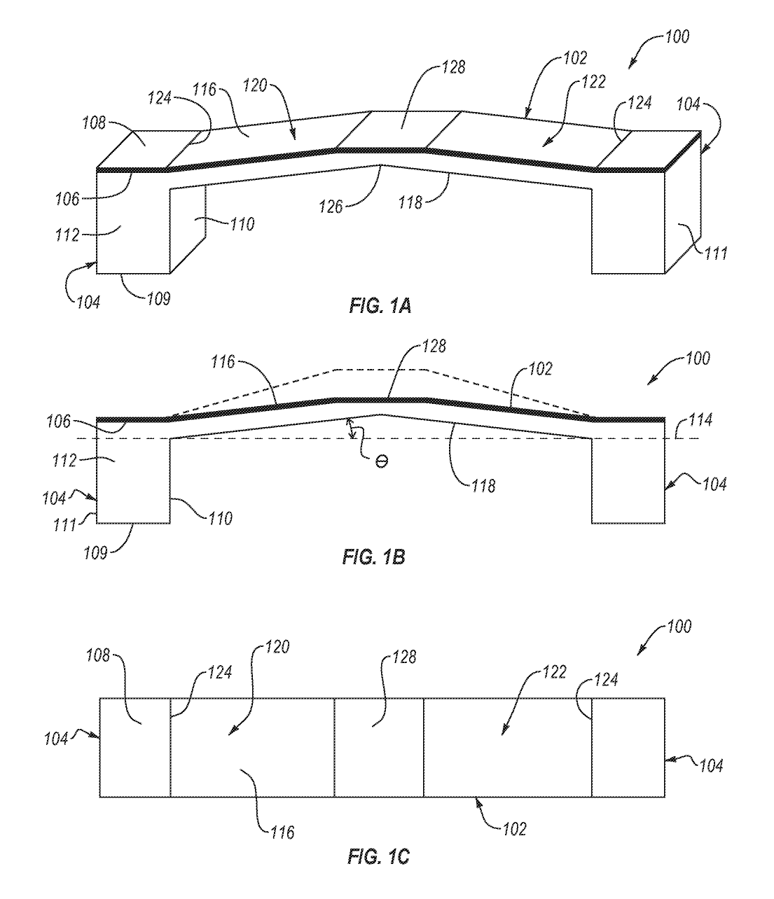

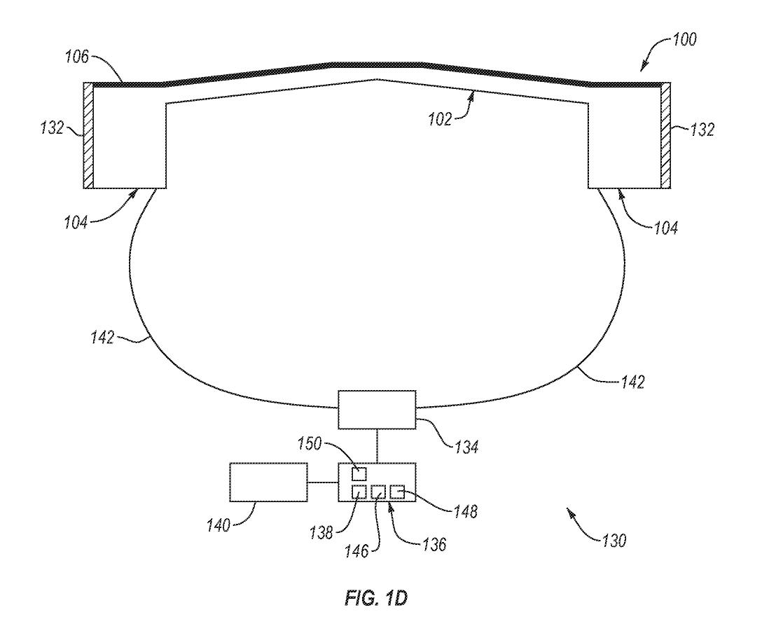

FIGS. 1A-1C are isometric, side elevational, and top plan views, respectively, of a thermal expansion actuator 100, according to an embodiment. The thermal expansion actuator 100 includes at least one beam 102 coupled to and extending generally longitudinally between a plurality of support portions 104. Each of the plurality of support portions 104 is spaced from each other. The thermal expansion actuator 100 also includes at least one heating element 106 configured to controllably or selectively heat at least a portion of the thermal expansion actuator 100.

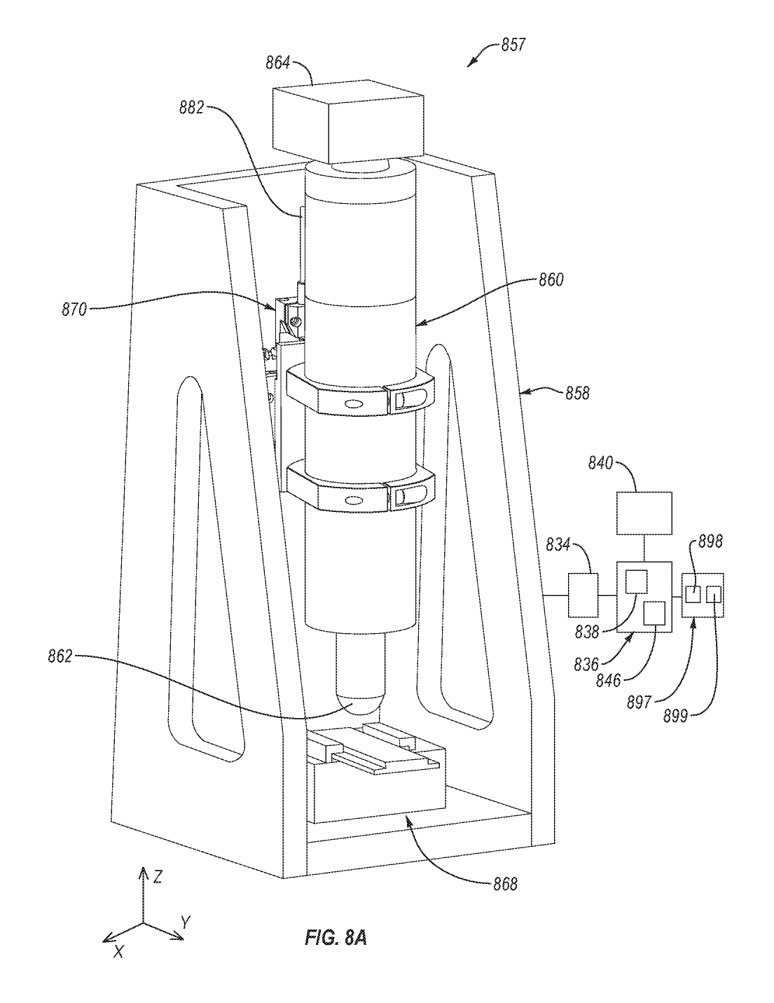

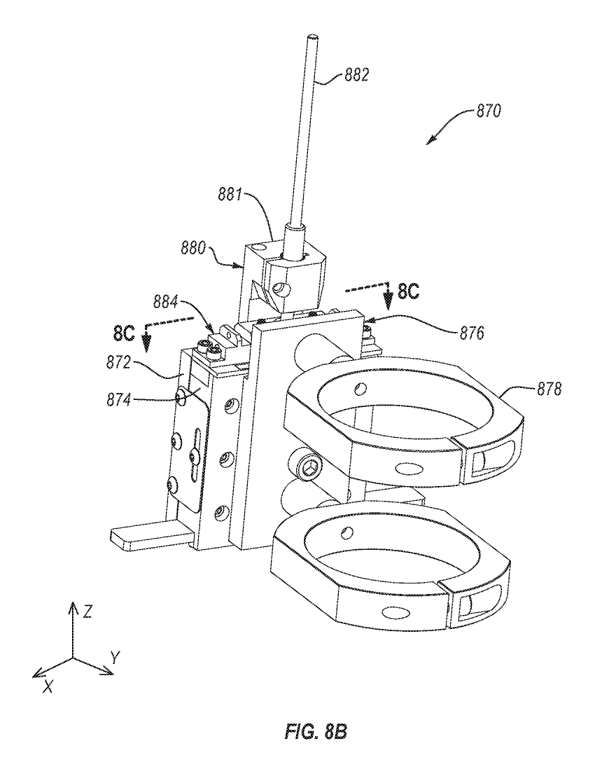

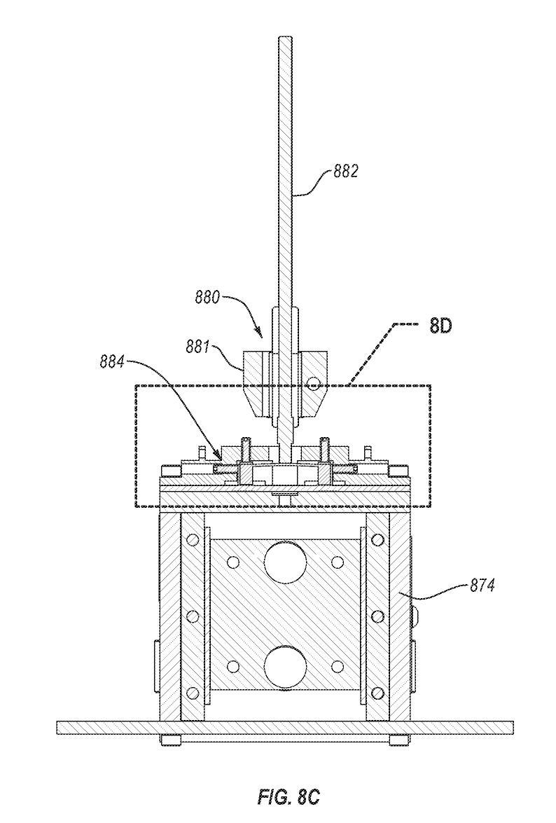

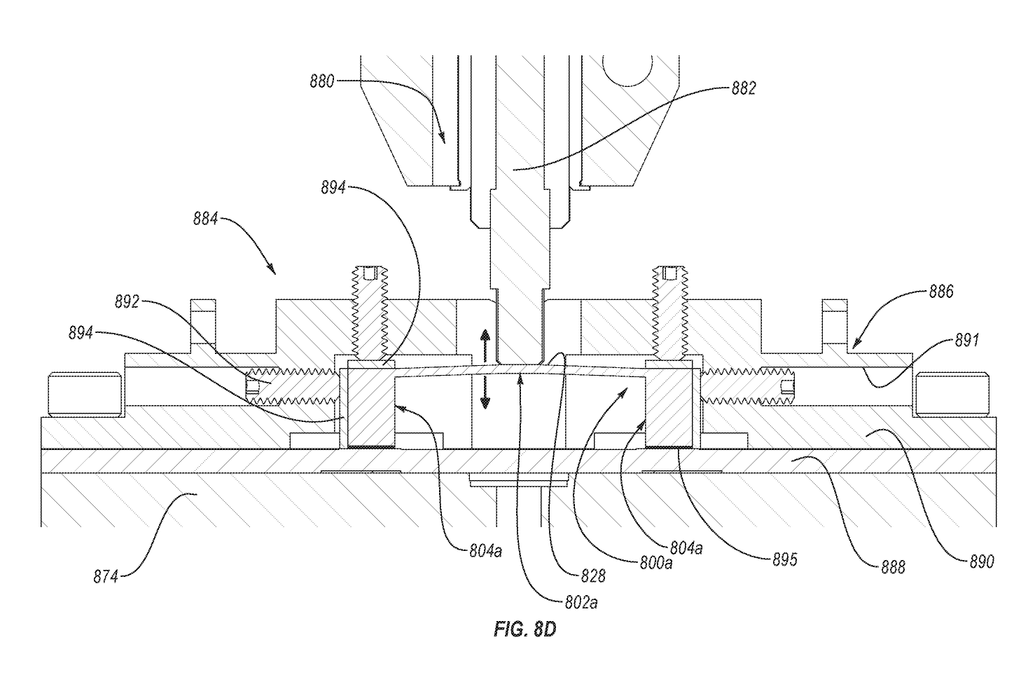

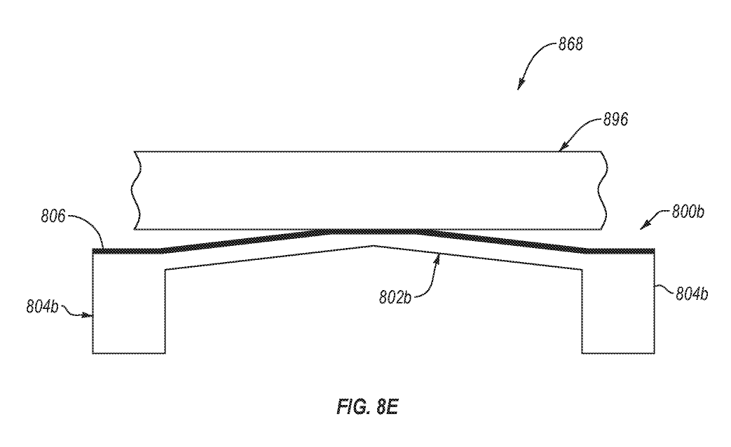

In operation, each of the plurality of support portions 104 can be coupled to a structure (e.g., one or more components of microscope 857 of FIG. 8A). The heating element 106 can then controllably or selectively heat at least a portion of the thermal expansion actuator 100 (e.g., the at least one beam 102, the support portions 104, or both) causing the at least one beam 102, the support portions 104, or both to expand. When the thermal expansion actuator 100 is controllably heated, the relative inability of the thermal expansion actuator 100 to expand (e.g., outwardly expand along a longitudinal axis 114) can cause a compressive force to be exerted on the thermal expansion actuator 100 and, in particular, on the at least one beam 102 thereof. The compressive force can cause the at least one beam 102 to be deflected (schematically shown with upper dashed line shown in FIG. 1B) in a direction that is substantially perpendicular to the longitudinal axis 114. For example, the at least one beam 102 generally defines and extends generally along the longitudinal axis 114, with the longitudinal axis extending between respective ends (first ends 124) of the at least one beam 102. Heating the thermal expansion actuator 100 can cause the at least one beam 102 to controllably or selectively deflect in nanometer or micrometer displacements. Similarly, cooling at least a portion of the thermal expansion actuator 100 after at least a portion of the thermal expansion actuator 100 is heated can cause the at least one beam 102 of the support portions 104 to contract and deflect in a generally opposite direction than when heated. When the thermal expansion actuator 100 is compressed (e.g., inwardly compress along the longitudinal axis 114) can cause a tensile force to be exerted on the thermal expansion actuator 100 and on the at least one beam 102. The tensile force can cause the deflection of the at least one beam 102 to be controllably or selectively decreased in nanometer or micrometer displacements.

In the illustrated embodiment, the support portions 104 exhibit a rectangular box-like shape. Each of the support portions 104 can include a top surface 108 that faces a direction that the at least one beam 102 deflects upon heating, a bottom surface 109 that generally opposes the top surface 108, an inner surface 110 that faces an inner surface 110 of another support portion 104, an outer surface 111 that generally opposes the inner surface 110, and side surfaces 112 that extend between the top, bottom, inner, and the outer surfaces 108, 109, 110, 111. Each of the top, bottom, inner, outer, and side surfaces 108, 109, 110, 111, 112 can be at least substantially planar (e.g., planar). However, at least one of the top, bottom, inner, outer, or side surface 108, 109, 110, 111, 112 can exhibit a convex curvature, a concave curvature, or another suitable topography. Although the support portions 104 disclosed are illustrated and described as exhibiting a rectangular box-like shape, it is understood that the support portions 104 can exhibit any suitable geometry. The support portions 104 can include additional surfaces or omit at least one of the top, bottom, inner, outer, or side surfaces 108, 109, 110, 111, 112

In an embodiment, the support portions 104 can exhibit a thickness (e.g., measured between the top and bottom surfaces 108, 109) that is greater than a thickness of at least a portion of the at least one beam 102 (e.g., measured substantially perpendicularly from an upper surface 116 to a lower surface 118 of the at least one beam 102). Increasing the thickness of the support portions 104 relative to the thickness of the at least one beam 102 can increase the deflection of the at least one beam 102 and decrease the deflection in the support portions 104. The support portions 104 can exhibit a thickness 2, 3, 4, 5, 6, 7, 8, 9, 10, 11, 12, 13, 14, 15, 16, 17, 18, 19, 20, or over 20 times greater than the thickness of the at least one beam 102, including ranges between any of the listed values.

In an embodiment, the at least one beam 102 is integrally formed with the support portions 104 such that the at least one beam 102 and the support portions 104 are formed from a single piece of material (e.g., monolithic). In an embodiment, the at least one beam 102 can be distinct and separate from the support portions 104 and attached to the support portions 104. The at least one beam 102 can be soldered, brazed, adhesively bonded to, mechanically attached to, or otherwise attached to the support portions 104.

In an embodiment, the at least one beam 102 can at least partially extend from the inner surface 110 of at least one of the support portions 104. The at least one beam 102 can extend from an uppermost portion of the inner surface 110, a bottommost portion of the inner surface 110, or any other portion of the inner surface 110 therebetween. In an embodiment, the at least one beam 102 can at least partially extend from the top surface 108 or another surface of at least one of the support portions 104.

The at least one beam 102 can include one or more arms that collectively define the at least one beam 102. In an embodiment, the at least one beam 102 can include a single arm coupled to and extending between the support portions 104. The single arm can define a single generally arcuate arm. In an embodiment, the at least one beam 102 can include a plurality of arms. The at least one beam 102 can include a first arm 120 and a second arm 122 that extend from respective support portions 104. The first and second arms 120, 122 can include a first end 124 coupled to the support portions 104 and a second end 126 spaced from the first end 124. In an embodiment, the at least one beam 102 can include one or more additional arms coupled to and extend between the first and second arms 120, 122. At least some of the first and second arms 120, 122 can be formed from a single piece of material or can be formed from distinct pieces attached together.

Each of the first and second arms 120, 122 can be substantially planar (e.g., an upper or lower surface 116, 118 thereof is substantially planar) or can be curved. The first and second arms 120, 122 can be coupled together such that the entire beam 102 is generally curved convexly outwardly relative to the support portions 104 (e.g., the at least one beam 102 can be curved or angular outwardly relative to the top surface 108 and the bottom surface 109). The generally arcuate shape of the at least one beam 102 can cause the at least one beam 102 to deflect away from the top surface 108 and the bottom surface 109 of the support portions 104 when the thermal expansion actuator 100 is heated.

The at least one beam 102 can extend longitudinally relative to the longitudinal axis 114 at a non-perpendicular, oblique angle θ relative to the longitudinal axis 114 and the inner surface 110 of the support portions 104. Referring to FIG. 1B, the first and second arms 120, 122 extend from the support portions 104 at an non-perpendicular, oblique angle θ relative to the longitudinal axis 114. When the first or second arm 120, 122 are substantially planar (e.g., planar), the non-perpendicular, oblique angle θ can be the smallest angle measured from the longitudinal axis 114 to at least one of the upper surface 116 or the lower surface 118. When the first or second arm 120, 122 is curved, the non-perpendicular, oblique angle θ can be the smallest angle measured from the longitudinal axis 114 to a slope of at least one of the upper surface 116 or the lower surface 118 at the first end 124. The oblique angle θ can be greater than 0°, 1°, 2°, 3°, 4°, 5°, 6°, 7°, 8°, 9°, 10°, 11°, 12°, 13°, 14°, 15°, 16°, 18°, 20°, 25°, 30°, 35°, 40°, 45°, or greater than 45°, including ranges including any combination of the listed values. In an embodiment, the non-perpendicular, oblique angle θ can be selected to be relatively small (e.g., less than about 15°) when the thermal expansion actuator 100 is configured to exhibit a relatively large deflection with a selected temperature gradient. In an embodiment, the non-perpendicular, oblique angle θ can be selected to be relatively large (e.g., greater than about 15°) when the thermal expansion actuator 100 is configured to exhibit a relatively small deflection with the same selected temperature gradient.

In an embodiment, each of the first and second arms 120, 122 can exhibit a length (e.g., the distance or arc length measured from the first end 124 to the second end 126 thereof) thereof that is at least about 2 mm (e.g., measured along the upper surface 116, the lower surface 118, or a plane therebetween). Each of the first and second arms can exhibit of length of 2 mm, 3 mm, 4 mm, 5 mm, 6 mm, 7 mm, 8 mm, 9 mm, 10 mm, 11 mm, 12 mm, 13 mm, 14 mm, 15 mm, or greater than 15 mm, including ranges including any combination of the listed values. The length of each of the arms can be the same or at least some arms can exhibit different lengths.

In an embodiment, the total length of the at least one beam 102 (e.g., from first end 124 to first end 124) can be greater than about 4 mm (e.g., measured along the upper surface 116, the lower surface 118, or a plane therebetween). The length of the at least one beam 102 can be 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 22 mm, 24 mm, 26 mm, 28 mm, 30 mm, or greater than 30 mm, including ranges between any of the listed values. It is believed by the inventors that when the at least one beam 102 has a length less than about 4 mm, the at least one beam may not have a sufficient strength to operate in a typical microscope (e.g., microscope 857 of FIG. 8A) and may not deflect sufficiently to scan a thick malaria smear.

In the illustrated embodiment, the upper surface 116 of the at least one beam 102 includes an apex 128 that is at least substantially planar (e.g., planar). The apex 128 can extend at an angle substantially parallel (e.g., parallel) to the longitudinal axis 114. The at least substantially planar surface of the apex 128 can facilitate contact between the apex 128 and an element that interfaces with the apex 128 (e.g., rod 882 of FIGS. 8C-8D). In an embodiment, the apex 128 can include any suitable surface topography. For example, the apex 128 can exhibit a concave curvature, a convex curvature, an angular topography, or another suitable topography. The apex 128 can be formed in one arm, or in two or more arms (e.g., the first and second arms 120, 122).

Referring to FIG. 1C, the surfaces of the at least one beam 102 can be imperforate and not include, for example, one or more slots, recesses, notched, divots, textures, etc. formed. Such an embodiment can increase the efficiency of the manufacturing process used to form the thermal expansion actuator 100 and increase the overall force that can be applied to the thermal expansion actuator.

The thermal expansion actuator 100 can be formed from one or more suitable materials. The one or more suitable materials can selected based on the material's properties and the application of the thermal expansion actuator 100. The maximum elastic deflection of the at least one beam 102 depends on the material's modulus of elasticity, yield strength, and the geometry of the at least one beam 102. In an embodiment, the materials for the at least one beam 102 can be selected to exhibit a relatively high thermal conductivity, which can cause the thermal expansion actuator 100 to be heated more uniformly, thereby increasing expansion of the thermal expansion actuator 100 at a selected temperature, decreasing thermal stresses and strains in the thermal expansion actuator 100, etc. For instance, the materials can exhibit a thermal conductivity that is greater than about 25 W/(m*K), greater than about 50 W/(m*K), more particularly greater than about 100 W/(m*K) or, even more particularly, greater than about 200 W/(m*K). In an embodiment, the materials can exhibit a linear coefficient of thermal expansion that is about 5*10⁻⁶/K to about 40*10⁻⁶/K. Increasing the linear coefficient of thermal expansion of the material can increase the deflection of the at least one beam 102 with less heating. The materials can be selected to maintain their material properties (e.g., mechanical properties) after being deformed (e.g., cycled) at least 50,000 times, such as at least 100,000 times, at least 500,000 times, or at least 1,000,000 times. For example, the thermal expansion actuator 100 can be cycled at least 300 times to analyze a single thick malaria smear. Elastically deflecting the at least one beam 102 can greatly increase the cyclability compared to plastically deflecting the at least one beam 102. As such, the thermal expansion actuator 100 can be formed from one or more of bronze, brass, copper, aluminum, iron, nickel, tin, zinc, gold, silver, aluminum brass, another suitable material, or alloys thereof.

The at least one heating element 106 can be any suitable device configured to heat at least a portion of the thermal expansion actuator 100. In an embodiment, the heating element 106 can be configured to heat at least a portion of the thermal expansion actuator 100 when electricity passes through at least a portion of the thermal expansion actuator 100 (e.g., the heating element 106 is the electrical resistance of thermal expansion actuator 100). For example, the heating element 106 can heat at least a portion of the thermal expansion actuator 100 when electricity passes from one support portion 104 to another support portion 104 via resistance heating. However, several materials that can form the thermal expansion actuator 100 exhibit low electrical resistance. In such an embodiment, a relatively large current must pass through the thermal expansion actuator 100 to deflect the at least one beam 102 which decreases the efficiency of the thermal expansion actuator 100.

In the illustrated embodiment, the heating element 106 includes at least one coating applied to at least a portion of at least one surface of the thermal expansion actuator 100. The coating can be applied to at least one of the top, bottom, inner, outer, side, upper, or lower surface 108, 109, 110, 111, 112, 116, 118 of the thermal expansion actuator. The coating can include a material that exhibits a first electrical resistance and the rest of the thermal expansion actuator 100 (e.g., the at least one beam 102 or the supports 104) can exhibit an exhibit a second electrical resistance that is less than the first electrical resistance. For example, the coating can exhibit an electrical resistivity 10¹, 10², 10³, 10⁴, 10⁵, 10⁶, 10⁸, 10¹⁰, 10¹², 10¹⁴, 10¹⁶, 10¹⁸, 10²⁰, 10²⁵, or greater than 10²⁵ time greater than the electrical resistivity of the rest of the thermal expansion actuator 100, including ranges including any combination of the listed values. Passing an electrical current through at least a portion of the thermal expansion actuator 100 (e.g., at least partially through the coating) can generate sufficient heat to deflect the at least one beam 102 at lower electrical currents. In an embodiment, the coating can include an oxide of a material that forms at least a portion of the thermal expansion actuator 100. If the support portions 104 or the at least one beam 102 includes aluminum, the coating can include an aluminum oxide coating (e.g., anodized aluminum). In an embodiment, the coating can include a physical vapor deposition (“PVD”) coating, a chemical vapor deposition (“CVD”) coating, an electrochemical deposited coating, or another suitable coating.

In an embodiment, the coating can exhibit a thickness that does not significantly affect the mechanical properties of the thermal expansion actuator 100. The thickness of the coating can be about 25 nm, 50 nm, 75 nm, 100 nm, 200 nm, 300 nm, 400 nm, 500 nm, 750 nm, 1 μm, 5 μm, 10 μm, 50 μm, about 100 μm, or greater than about 100 μm, including ranges including any combination of the listed values. The thickness of the coating can be selected based on at least one of the one or more materials used to form the thermal expansion actuator 100, the one or more materials used to form the coating, the temperature to which the thermal expansion actuator 100 is heated, the expected elastic deflection of the at least one beam 102 (e.g., maximum elastic deflection of the at least one beam 102), the method used to form the coating (e.g., PVD, CVD), etc. In an embodiment, the heating element 106 can include any of the other heating elements disclosed.

In an embodiment, the heating element 106 is configured to controllably or selectively heat at least a portion of the thermal expansion actuator 100 such that the average temperature of the thermal expansion actuator 100 is about 1° C., 2° C., 3° C., 4° C., 5° C., 10° C., 15° C., 20° C., 25° C., 30° C., 40° C., 45° C., 50° C., 55° C., 60° C. 65° C., 70° C., 75° C., 80° C., 85° C., 90° C., 95° C., 100° C., 110° C., 120° C., 130° C., 140° C., 150° C., or greater than 150° C. above ambient temperature (e.g., 20° C.), including ranges including any combination of the listed values. The maximum temperature that the heating element 106 heats the thermal expansion actuator 100 above ambient temperature depends on the one or more materials that form the thermal expansion actuator 100, the length of the at least one beam 102, the ambient temperature, etc. For example, when the thermal expansion actuator 100 is formed from aluminum can be heated to a temperature of about 100° C. above ambient temperature.

The heating element 106 is configured to heat at least a portion of the thermal expansion actuator 100 such that the at least one beam 102 controllably or selectively exhibits 1 μm displacements or less with relatively high accuracy. For example, the heating element 106 can be configured to heat the thermal expansion actuator 100 such that the at least one beam 102 controllably or selectively exhibits about a 1 μm, 0.9 μm, 0.8 μm, 0.7 μm, 0.6 μm, 0.5 μm, 0.4 μm, 0.3 μm, 0.2 μm, 0.1 μm, 0.05 μm, or less than 0.05 μm displacements, including ranges including any combination of the listed values. For example, when the thermal expansion actuator 100 is configured to facilitate the detection of malaria, the at least one beam 102 can controllably or selectively exhibit about 0.5 μm displacements or less (e.g., about 0.3 μm displacement or less). In an embodiment, the heating element 106 is configured to heat at least a portion of the thermal expansion actuator 100 such that the total displacement of the at least one beam 102 is 1 μm, 5 μm, 10 μm, 15 μm, 20 μm, 25 μm, 30 μm, 35 μm, 40 μm, or more than 40 μm, including ranges including any combination of the listed values. For example, when the at least one beam 102 is formed from aluminum and exhibits a length of about 16 mm, the at least one beam 102 can controllably or selectively exhibit individual displacements of about 0.3 μm and about 1 μm when heated about 1° C. and about 3° C., respectively. As another example, the at least one beam 102 can exhibit a total displacement of about 10 μm when heated to about 30° C. above ambient temperature.

The deflection of the at least one beam 102 can decrease when the thermal expansion actuator 100 cools, allowing the thermal expansion actuator 100 to thermal contract. For example, the thermal expansion actuator 100 is cooled when the heating element 106 ceases to heat at least a portion of the thermal expansion actuator 100. In an embodiment, the heating element 106 can provide energy to the thermal expansion actuator 100 (e.g., at a rate that is less than the rate heat is dissipated from the thermal expansion actuator 100) when the thermal expansion actuator 100 is cooled, thereby decreasing the rate at which the thermal expansion actuator 100 is cooled.

In an embodiment, the thermal expansion actuator 100 can be configured to quickly dissipate heat therefrom (e.g., from the at least one beam 102), thereby increasing the rate at which the deflection of the at least one beam 102 can be decreased. For example, as previously discussed, the thermal expansion actuator 100 can be formed from a material exhibiting a thermal conductivity of about greater than about 25 W/(m*K). In an embodiment, the thermal expansion actuator 100 can include a heat sink incorporated therein or distinct therefrom and thermally coupled thereto. In an embodiment, the thermal expansion actuator 100 can include a textured surface (e.g., at least one of one or more recesses, one or more notched, one or more dimples, one or more protrusions, etc.), thereby increasing a surface area of the thermal expansion actuator 100. In an embodiment, the thermal expansion actuator 100 can be used in a system (e.g., system 130 of FIG. 1D) that includes a fan or similar device configured to actively increase the heat dissipated from the thermal expansion actuator 100.

FIG. 1D is a schematic cross-sectional view of a system 130 configured to controllably or selectively heat the thermal expansion actuator 100 shown in FIGS. 1A-1C, according to an embodiment. In the illustrated embodiment, expansion or contraction of the thermal expansion actuator 100 is constrained in at least one direction by a restraining element 132. The restraining element 132 schematically represents any of device (e.g., the plurality of threaded fasteners 892 or the plurality of spacers 894 shown in FIGS. 8C-8D) that can attach the thermal expansion actuator 100 to a structure and physically constrain the thermal expansion actuator 100. The heating element 106 is coupled (e.g., electrically coupled) to a power source 134 configured to provide power to the heating element 106 (e.g., electrical current) that the heating element 106 uses to heat at least a portion of the thermal expansion actuator 100. The power source 134 can be coupled (e.g., communicably coupled) to a controller 136 that includes control electrical circuitry 138. The control electrical circuitry 138 can be configured to control the power source 134. The system 130 further includes one or more sensors 140 configured to detect one of more characteristics of one or more components of the system 130 or the environment about the one or more components. The sensors 140 can be operably coupled to the controller 136 and the control electrical circuitry 138 can control the power source 134 responsive to the characteristics detected by the sensors 140.

The power source 134 can include any device configured to provide power to the heating element 106 such that the heating element 106 can heat at least a portion of the thermal expansion actuator 100. In an embodiment, the power source 134 can include a device configured pass an electrical current through at least a portion of the thermal expansion actuator 100. The electrical current can be provided as an alternating current or as a direct current. The power source 134 can include a battery, a power generating device (e.g., solar cells), a voltage source such as voltage provided from an electrical outlet, or any other suitable device.

In an embodiment, the power source 134 can be coupled to the thermal expansion actuator 100 using a plurality of electrical wires 142. Alternatively, an electrically conductive tape (e.g., copper tape), or another suitable electrical conductor may be used instead of the electrical wires 142. In an embodiment, the power source 134 can be wirelessly coupled to the thermal expansion actuator 100. For example, the power source 134 can provide power to the thermal expansion actuator 100 using electromagnetic energy (e.g., electromagnetic energy absorbed by the heating element 106), induction, etc. In an embodiment, the power source 134 can be directly attached to the thermal expansion actuator 100.

As previously discussed, the sensors 140 can be configured to detect one or more characteristics of one or more components of the system 130 or the environment thereabout. In an embodiment, the sensors 140 can include at least one thermal sensor (e.g., bimetal, thermistor, thermocouple, resistance thermometer, etc.). The thermal sensor can be configured to detect a temperature of at least a portion of the thermal expansion actuator 100 (e.g., the heating element 106 or the at least one beam 102) or an ambient temperature about the thermal expansion actuator 100. In an embodiment, the sensors 140 can include at least one displacement sensor configured to detect a displacement (e.g., elastic deflection) of the at least one beam 102. The displacement sensor can include any sensor configured to detect or quantify displacement that are a few micrometers, a micrometer, or, more particularly, less than a micrometer. The displacement sensor can include at least one of a magnetic displacement sensor, a capacitive displacement sensor, a piezoelectric displacement sensor, a mechanical displacement sensor, a linear displacement sensor (e.g., a string-potentiometer transducer, a linear variable differential transformer, an ultrasonic sensor, a linear encoder, a two-channel linear position encoder, a magnetostrictive position sensor), rotational position sensors (e.g., an absolute encoder, an incremental encoder, a rotary position encoder, a rack and pinion sensor, an absolute contact encoder disc) a two channel quadrature output linear optical encoder, an electro-mechanical displacement sensor (e.g., strain gauge), or another suitable sensors. In an embodiment, a camera of a microscope (e.g., camera 864 of microscope 857 of FIG. 8A) can be used to determine the displacement, for example, using a Brenner focus score.

In an embodiment, at least one of the sensors 140 can be at least partially disposed in, attached to, or incorporated into the thermal expansion actuator 100. In such an embodiment, the at least one sensor 140 can include a sensor configured to directly measure the temperature or displacement of the at least one beam 102 of the thermal expansion actuator 100. In an embodiment, at least one of the sensors 140 can be spaced from the thermal expansion actuator 100. For example, at least one of the sensors 140 can be at least partially disposed in, attached to, or incorporated into the power source 134, the controller 136, or the structure to which the thermal expansion actuator 100 is attached. In such an embodiment, the at least one sensor 140 can be configured to indirectly measure the temperature or displacement of the thermal expansion actuator 100, measure the ambient temperature, etc.

In an embodiment, the sensors 140 can transmit one or more sensing signals responsive to detecting the one or more characteristics of the system 130 or the environment thereabout. For example, the sensing signals can include data encoded therein indicating or at least partially related to the temperature of at least a portion of the thermal expansion actuator 100, the displacement of the at least one beam 102, the ambient temperature, or another detected characteristic. The sensors 140 can transmit the one or more sensing signals to one or more components of the system 130. The sensors 140 can transmit the sensing signals to the controller 136.

In an embodiment, the control electrical circuitry 138 of the controller 136 can control the operation of one or more components of the system 130 responsive to receiving the sensing signals. For example, the control electrical circuitry 138 can direct the power source 134 to increase or decrease the power provided to the thermal expansion actuator 100 responsive to receiving the sensing signals.

In an embodiment, the controller 136 can be spaced from at least one of the thermal expansion actuator 100, the power source 134, or the sensors 140. In an embodiment, the controller 136 can be at least partially disposed in, attached to, or incorporated into at least one of the thermal expansion actuator 100, the power source 134, or the sensors 140.

The controller 136 can be communicably coupled, either directly or indirectly, to one or more components of the system 130. The controller 136 can be wiredly or wirelessly (e.g., Bluetooth, Wi-Fi) coupled to the components of the system 130.

The controller 136 can further include memory 146 or the memory 146 can be separate from and communicably coupled to the controller 136. The memory 146 can be configured to store one or more operational instructions or one or more sensing signals. The memory 146 can include non-transitory memory, such as random access memory (RAM), read only memory (ROM), a hard drive, a disc, flash memory, other types of memory electrical circuitry, or other suitable memory. The operational instructions stored on the memory 146 can include how much power (e.g., electrical current) is required to raise the temperature of the thermal expansion actuator 100 a certain amount, the expected deflection of the at least one beam 102 after increasing or decreasing the temperature of the thermal expansion actuator 100, when to heat the thermal expansion actuator 100, etc.

In addition or alternative to the memory 146, the controller 136 can include a receiver 148 configured to receive one or more operational instructions from a user or another device. The receiver 148 can be communicably coupled to and receive operational instructions from a device (e.g., computer, cellphone, etc.) that is spaced from the receiver 148. The receiver 148 can then transmit the received operational instructions to at least one of a processor 150 or the memory 146 (e.g., the receiver 148 is communicably coupled to at least one of the processor 150 or the memory 146). In an embodiment, the receiver 148 can also form part of a transceiver that is configured to transmit information therefrom. The transceiver can transmit information to a device (e.g., computer, cellphone) in which the transmitted information can be compiled, stored, or accessed. The transmitted information can include the sensing signals, the status of the system 130, etc.

The controller 136 can further include a processor 150 configured to direct certain operations of the system 130 according to the operational instructions. The processor 150 can receive the operational instructions from the memory 146 or the receiver 148.

As previously discussed, the controller 136 includes the control electrical circuitry 138. The control electrical circuitry 138 can be integrally formed with at least one of the memory 146, the receiver 148, or the processor 150. The control electrical circuitry 138 can be separate from the memory 146, the receiver 148, and the processor 150. In such an embodiment, the control electrical circuitry 138 can include its own memory, receiver, or processor.

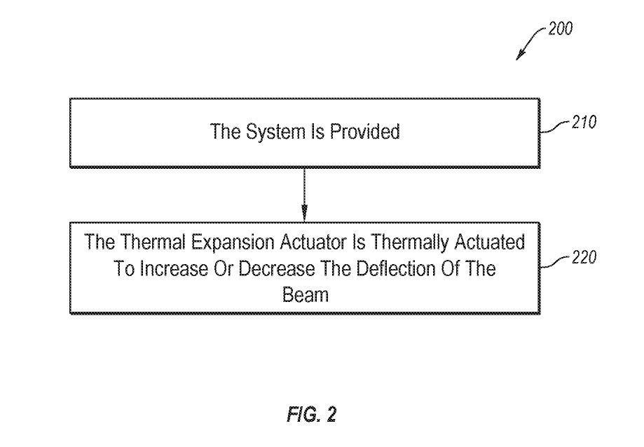

FIG. 2 is a flow diagram of a method 200 of using the system 130 disclosed, according to an embodiment. In some embodiments, some acts of the method 200 can be split into a plurality of acts, some acts can be combined into a single act, and some acts can be omitted. Also, it is understood that additional acts can be added to method 200.

In act 205, the system 130 is provided. In an embodiment, the thermal expansion actuator 100 can be at rest. The thermal expansion actuator 100 be initially at rest when the thermal expansion actuator 100 is at or near ambient temperature. In an embodiment, the thermal expansion actuator 100 can be initial exhibit a temperature that is above ambient temperature.

In act 210, the thermal expansion actuator 100 is thermally actuated to increase or decrease the deflection of the at least one beam 102. The at least one beam 102 can be elastically deflected. In an embodiment, the deflection of the at least one beam 102 is increased by actively heating the thermal expansion actuator 100 (e.g., providing power to the heating element 106). The thermal expansion actuator 100 can be actively heated by passing an electrical current between two support portions 104. In an embodiment, the thermal expansion actuator 100 can be actively heated by using any of the other methods or heating elements disclosed. In an embodiment, the deflection of the at least one beam 102 is decreased by cooling the thermal expansion actuator 100. For example, the temperature of the thermal expansion actuator 100 is decreased by reducing the power supplied to the heating element 106. In an embodiment, the at least one beam 102 can be deflected in 1 μm increments of less.

In an embodiment, the system 130 can maintain the deflection of the at least one beam 102. For example, the heating element 106 can heat the thermal expansion actuator 100 at substantially the same rate as heat is dissipated from the thermal expansion actuator 100.

In an embodiment, the power source 134 or the sensors 140 can operate responsive to one or more directions received from the control electrical circuitry 138. The power source 134 can provide power to the heating element 106 responsive to receiving directions from the control electrical circuitry 138. In an embodiment, the sensors 140 can detect one or more characteristics responsive to receiving directions from the control electrical circuitry 138.

In an embodiment, the sensors 140 can detect one or more characteristics of the system 130. In an embodiment, the sensors 140 can detect the temperature of one or more portions of the thermal expansion actuator 100 or the ambient temperature about the thermal expansion actuator 100. In an embodiment, the sensors 140 can detect the deflection of the at least one beam 102. The sensors 140 can transmit one or more sensing signals responsive to detecting the characteristics of the system 130. The sensing signals can include the detected characteristics encoded.

In an embodiment, the controller 136 can receive the sensing signals from the sensors 140. The control electrical circuitry 138 can control the operation of one or more components of the system 130 responsive to receiving the sensing signals. The sensing signals can indicate to the controller 136 that the at least one beam 102 is under or over deflected. The control electrical circuitry 138 can direct the power source 134 to increase or decrease the power provided to the thermal expansion actuator 100. In an embodiment, the sensing signals can indicate that the ambient temperature is increasing. The control electrical circuitry 138 can direct the power source 134 to decrease or increase the power provided to the thermal expansion actuator 100.

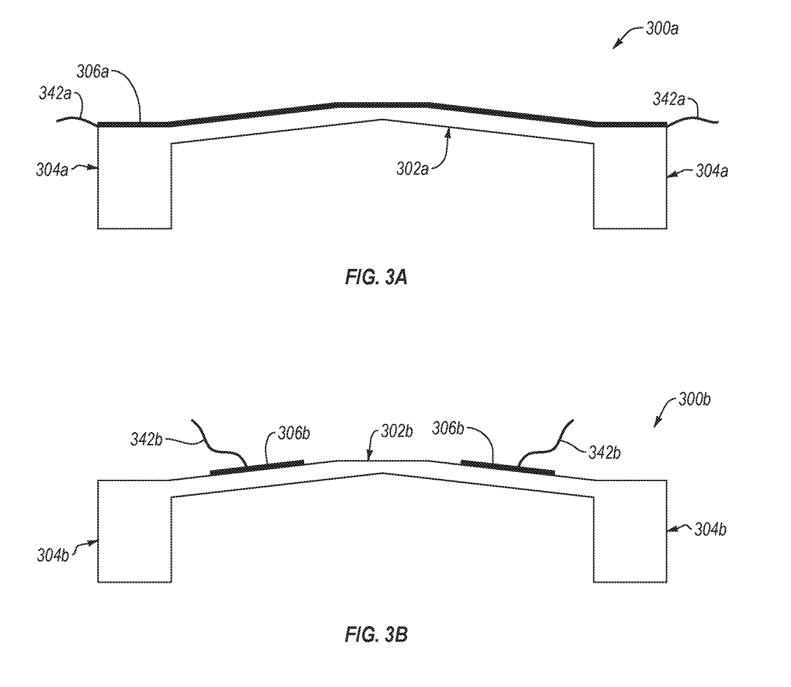

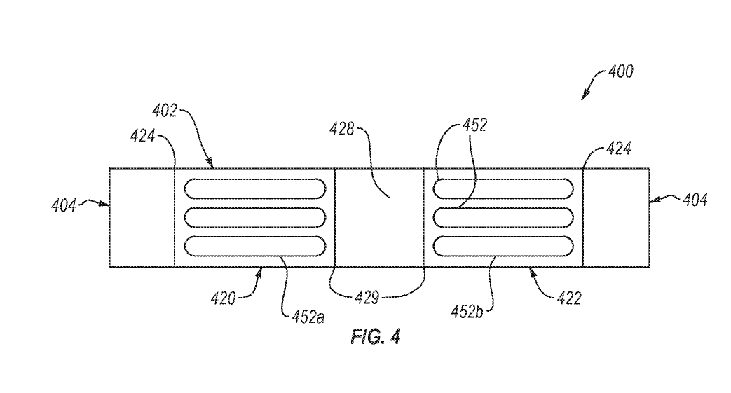

As previously discussed, a heating element can include a coating disposed on at least one surface of a thermal expansion actuator. However, the heating element can include any suitable device configured to heat at least a portion of the thermal expansion actuator. FIGS. 3A and 3B are schematic cross-sectional views of thermal expansion actuators that include different heating elements, according to different embodiments. Except as otherwise described herein, the thermal expansion actuators shown in FIGS. 3A-3B and their materials, components, or elements can be similar to or the same as the thermal expansion actuator 100 (FIGS. 1A-1D) and its respective materials, components, or elements. The heating elements illustrated in FIGS. 3A-3B can be used in any of the thermal expansion actuator embodiments disclosed herein.

Referring to FIG. 3A, a thermal expansion actuator 300a is illustrated that includes at least one beam 302a coupled to and extending between a plurality of support portions 304a. The thermal expansion actuator 300a also includes at least one heating element 306a. The heating element 306a can include at least one layer at least partially disposed in the thermal expansion actuator 300a. The heating element 306a can include a layer at least partially disposed within at least one of the beam 302a or the support portion 304a. The heating element 306a can include 1, 2, 3, 4, 5, 6, 7, 8, 9, 10, or over 10 layers, including ranges including any combination of the listed values.

In an embodiment, the layer can exhibit an electrical resistance that is greater than the electrical resistance of the rest of the thermal expansion actuator 300a. For example, the thermal expansion actuator 300a can be formed from a metallic material (e.g., aluminum) and the layer can be formed from an oxide thereof. In an embodiment, the layer can exhibit a thickness that is about 10 nm, 25 nm, 50 nm, 100 nm, 200 nm, 300 nm, 400 nm, 500 nm, 750 nm, 1 μm, 5 μm, 10 μm, 50 μm, 100 μm, or greater than about 100 μm, including ranges including any combination of the listed values. The thickness of the layer can be selected based on at least one of the one or more materials used to form the thermal expansion actuator 300a, the one or more materials used to form the layer, the temperature to which the thermal expansion actuator 300a is heated, the maximum elastic deflection of the beam 302, etc. In an embodiment, the layer can be directly coupled to a power source (not shown) via wires 342a. In an embodiment, the layer can be indirectly coupled to the power source.

Referring to FIG. 3B, a thermal expansion actuator 300b is illustrated that includes at least one beam 302b coupled to and extending between a plurality of support portions 304b. The thermal expansion actuator 300b also includes at least one heating element 306b. The heating element 306b can include one or more external resistive heaters. For example, the external resistive heaters can include a Thermofoil™ heater available from Minco Corporation. In an example, the external resistive heaters can include a chip power resister (e.g., positive temperature coefficient chip) that is mounted to a surface of the thermal expansion actuator 300b (e.g., using a thermal grease). In an example, the external resistive heaters can include a Kapton® polyimide film heater. The external resistive heaters are positioned and configured to heat at least a portion of the thermal expansion actuator 300b. The external resistive heaters can be directly mounted to or mounted near at least one of the beam 302b or the support portions 304b using an adhesive or another suitable attachment technique. In an embodiment, the external resistive heaters can be directly coupled to a power source (not shown) via wires 342b. In an embodiment, the external resistive heaters can be indirectly coupled to the power source.

FIG. 4 is a top plan view of a thermal expansion actuator 400 including one or more slots 452 formed therein, according to an embodiment. Except as otherwise described herein, the thermal expansion actuator 400 shown in FIG. 4 and its materials, components, or elements can be similar to or the same as the thermal expansion actuators 100, 300a, 300b (FIGS. 1A-1D, 3A-3B) and their respective materials, components, or elements. The slots 452 illustrated in FIG. 4 can be used in any of the thermal expansion actuator embodiments disclosed herein.

In the illustrated embodiment, the thermal expansion actuator 400 includes at least one beam 402 coupled to and extending between the plurality of support portions 404. The at least one beam 402 includes a plurality of arms, such as a first arm 420 and a second arm 422. Each of the first and second arms 420, 422 can include a first end 424 coupled to the support portions 404 and a second end spaced from the first end 424 (e.g., the second end can be at an edge 429 of the apex 428 or between the edges 429 of the apex 428). The thermal expansion actuator 400 also includes at least one heating element (not shown for clarity) configured to controllably and selectively heat at least a portion of the thermal expansion actuator 400. For example, the thermal expansion actuator 400 can be electrically coupled to a power source (not shown) configured to provide power to the at least one heating element.

As previously discussed, the at least one beam 402 can include one or more slots 452 formed. The slots 452 decreases the volume and mass of the at least one beam 402, thereby decreasing the energy needed to controllably or selectively increase the temperature of at least a portion of the thermal expansion actuator 400 (e.g., the at least one beam 402) and increases the rate at which the heating element (not shown for clarity) controllably or selectively heats at least a portion of the thermal expansion actuator 100. For example, it is currently believed that the slots 452 can decrease the time required to heat the thermal expansion actuator 400 by about half compared to a thermal expansion actuator that does not include slots. The slots 452 also increase the surface area of the at least one beam 402 increasing the rate at which heat is dissipated from the at least one beam 402. The slots 452 can increase the flexibility of the at least one beam 402.

The at least one beam 402 can include 1, 2, 3, 4, 5, 6, 7, 8, 9, 10, 12, 14, 16, 18, 20, or over 20 slots 452 formed, including ranges including any combination of the listed values. At least some slots 452 can extend through a thickness of the at least one beam 402 or can extend through only a portion of the thickness of the at least one beam 402. The slots 452 can extend for a selected length along the at least one beam 402 that is greater than zero and less than the total length of the at least one beam 402. At least some slots 452 can extend from or near the first end 424 to or near at least one of the second end of the same arm, the edge 429 of the apex 428, or between the edges 429 of the apex 428. For example, the slots 452 can include a first slot 452a that extends from or near the first end 424 of the first arm 420 and a second slot 452b that extends from or near the first end 424 of the second arm 422.

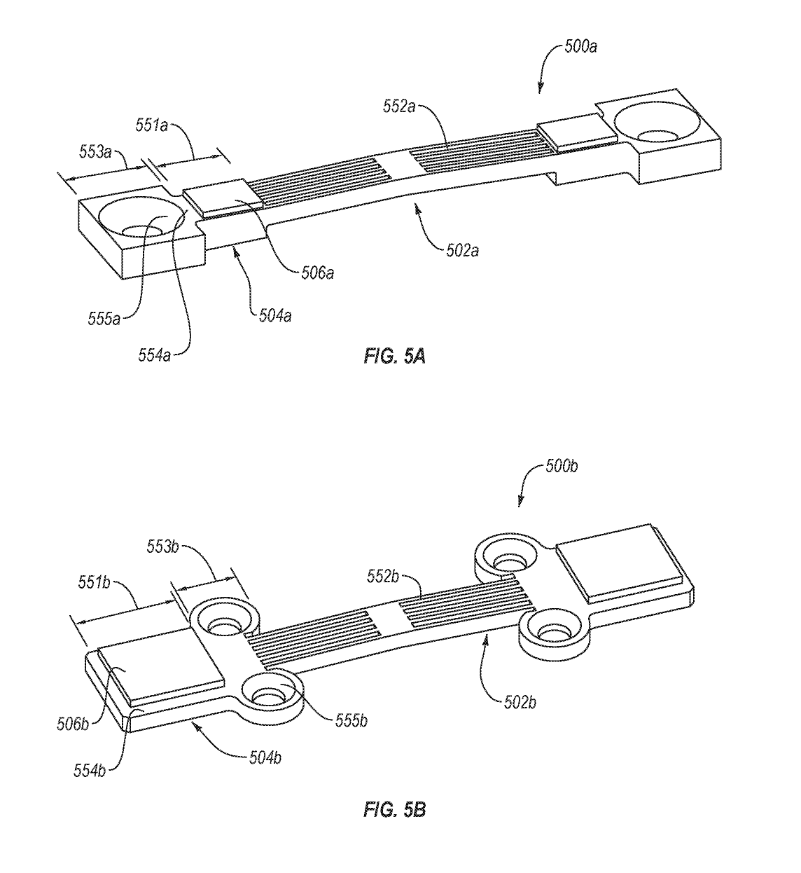

In an embodiment, any of the thermal expansion actuators disclosed herein can include one or more locations spaced from the at least one beam configured to receive an external resistive heater or any other heating element disclosed herein. FIGS. 5A and 5B are isometric views of thermal expansion actuators that include one or more receiving areas spaced from the at least one beam configured to have any of the heating elements disclosed herein positioned therein or thereon, according to different embodiments. Except as otherwise described herein, the thermal expansion actuators shown in FIGS. 5A-5B and their materials, components, or elements can be similar to or the same as the thermal expansion actuators 100, 300a, 300b, 400 (FIGS. 1A-1D, and 3A-4) and their respective materials, components, or elements. The heating elements illustrated in FIGS. 5A-5B can be used in any of the thermal expansion actuator embodiments disclosed herein.

Referring to FIG. 5A, a thermal expansion actuator 500a includes at least one beam 502a extending between a plurality of support portions 504a. In the illustrated embodiment, the at least one beam 502a includes a plurality of slots 552a. However, it is understood that the plurality of slots 552a can be omitted.

Each support portion 504a includes a first portion 551a and a second mounting portion 553a. The first portion 551a includes the at least one beam 502a extending therefrom and is positioned between the second mounting portion 553a and the at least one beam 502a. The first portion 551a includes a surface 554a (e.g., the uppermost surface or any other suitable surface thereof) having at least one heating element 506a (e.g., any of the heating elements disclosed herein) mounted, secured, attached, incorporated therein, or otherwise positioned thereon. For example, the at least one heating element 506a can be a surface mounted resistor that is mounted on a printed circuit board. The surface 554a can include any suitable topography (e.g., planar or curved topography) or surface area that corresponds to the at least one heating element 506a. The second mounting portion 553a is configured to secure the thermal expansion actuator 500a to another structure. In an example, the second mounting portion 553a can define at least one hole 555a (e.g., a single hole or a plurality of holes) that is configured to receive a bolt, screw, or another suitable device that secures the thermal expansion actuator 500a to the another structure. In an example, the second mounting portion 553a can be configured to be brazed, welded, mechanically fastened, or otherwise secured to the another structure (e.g., the at least one hole 555a can be omitted).

Referring to FIG. 5B, a thermal expansion actuator 500b includes at least one beam 502b extending between a plurality of support portions 504b. In the illustrated embodiment, the at least one beam 502b includes a plurality of slots 552b. However, it is understood that the plurality of slots 552b can be omitted.

Each support portion 504b includes a first portion 551b and a second mounting portion 553b. Similar to the thermal expansion actuator 500a (FIG. 5A), the first portion 551b includes a surface 554b (e.g., the uppermost surface or any other suitable surface thereof) having at least one heating element 506b attached thereto and the second mounting portion 553b is configured to secure the thermal expansion actuator 500b to another structure using, for example, at least one hole 555b (e.g., a single hole or a plurality of holes). However, the second mounting portion 553b can be positioned between the first portion 551b and the at least one beam 502b such that the at least one beam 502b extends from the second portion 553b.

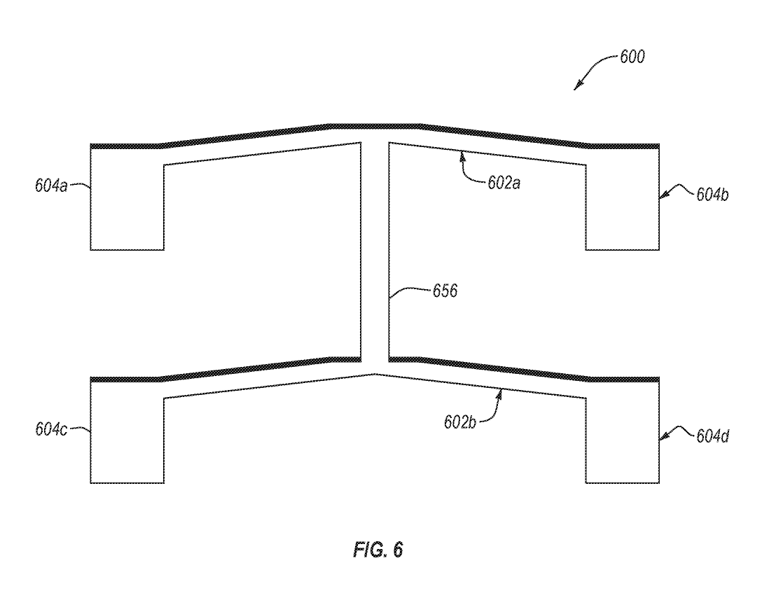

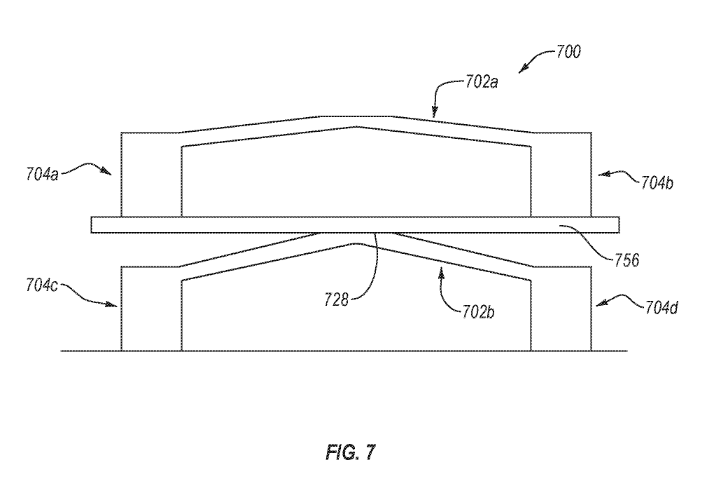

FIG. 6 is a schematic cross-sectional view of a thermal expansion actuator 600 including a plurality of beams coupled to and extending between a plurality of support portions 604a-d, according to an embodiment. Except as otherwise described herein, the thermal expansion actuator 600 shown in FIG. 6 and its materials, components, or elements can be similar to or the same as the thermal expansion actuators 100, 300a, 300b, 400, 500a, 500b (FIGS. 1A-1D, 3A-5B) and their respective materials, components, or elements. The thermal expansion actuator 600 illustrated in FIG. 6 can be used in any of the thermal expansion actuator embodiments disclosed herein.

In the illustrated embodiment, the plurality of beams can include a first beam 602a and a second beam 602b positioned below the first beam 602a. However, it is understood the plurality of beams can include more than two beams. In an embodiment, the first and second beams 602a, 602b can be configured substantially the same or similarly. In an embodiment, the first and second beams 602a, 602b can be different. The first beam 602a can exhibit a length that differs from the second beam 602b. In another example, the first and second beams 602a, 602b can be heated using a different heating elements.

The first and second beams 602a, 602b can be coupled to and extend between the plurality of support portions. In the illustrated embodiment, the first beam 602a can be coupled to and extend between a first support portion 604a and a second support portion 604b while the second beam 602b can be coupled to and extend between a third support portion 604c and a fourth support portion 604d. In an embodiment, the first and second beams 602a, 602b can be coupled to extend from at least one common support portion (e.g., coupled to and extend from different portions of the common support portion). In an embodiment, the thermal expansion actuator 600 includes at least one shaft 656 coupled to and extending between the first and second beams 602a, 602b. The shaft 656 can cause the first and second beams 602a, 602b to act in unison and enable the second beam 602b to support at least some of the load applied to the first beam 602a, or vice versa.

FIG. 7 is a schematic cross-sectional view of a thermal expansion actuator 700 including a plurality of beams coupled to and extending between a plurality of support portions, according to an embodiment. Except as otherwise described herein, the thermal expansion actuator 700 shown in FIG. 7 and its materials, components, or elements can be similar to or the same as the thermal expansion actuators 100, 300a, 300b, 400, 500a, 500b, 600 (FIGS. 1A-1D, 3A-6) and their respective materials, components, or elements. The thermal expansion actuator 700 illustrated in FIG. 7 can be used in any of the thermal expansion actuator embodiments disclosed herein.

In the illustrated embodiment, the plurality of beams can include a first beam 702a and a second beam 702b positioned below the first beam 702a. However, it is understood the plurality of beams can include more than two beams. In an embodiment, the first and second beams 702a, 702b can be configured substantially the same or similar. In an embodiment, the first and second beams 702a, 702b can be different (e.g., one of the beams can include slots while the other of the beams does not include slots, the thickness or length of the beams can be different, etc.).

The first and second beams 702a, 702b can be coupled to and extend between the plurality of support portions. In the illustrated embodiment, the first beam 702a can be coupled to and extend between a first support portion 704a and a second support portion 704b, while the second beam 702b can be coupled to and extend between a third support portion 704c and a fourth support portion 704d. In an embodiment, the thermal expansion actuator 700 includes at least one plank 756, plate, disc, or other structure. The plank 756 can be coupled to and extend between the first and second support portions 704a, 704b at a location below the first beam 702a. A portion of the plank 756 (e.g., a portion of the plank 756 centrally located between the first and second support portion 704a, 704b) can be coupled to the second beam 704b. For example, the plank 756 can be coupled to an apex 728 of the second beam 702b. As such, the plank 756 can add the deflection of the first beam 702a to the deflection of the second beam 702b to create the total deflection of the thermal expansion actuator 700.

As previously discussed, any of the thermal expansion actuators disclosed herein can be used in a focusing system of a microscope. FIG. 8A is an isometric view of a microscope 857 including a focusing system that includes any of the thermal expansion actuators disclosed herein, according to an embodiment. In the illustrated embodiment, the thermal expansion actuator is illustrated as the type shown in FIGS. 1A-1C, such as thermal expansion actuator 100. However, it should be noted that any of the thermal expansion actuators disclosed herein can be used in the microscope 857. In the illustrated embodiment, the microscope 857 includes a frame 858 configured to support one or more components of the microscope 857. The microscope 857 further includes a column 860 coupled to the frame 858, which can extend in a vertical direction (e.g., z-direction). The column 860 can be directly or indirectly coupled to the frame 858. For example, at least a portion of the column 860 can be coupled to the frame 858 via a column connector device (“connector”) 870. The column 860 includes at least one lens 862 (e.g., an oil immersion lens). In an embodiment, the at least one lens 862 can exhibit a depth of field that is only a few micrometers deep, about 1 micrometer deep, or less than a micrometer deep. The column 860 can also include a camera 864 or other image capture device attached to the column 860 and configured to capture images focused by the at least one lens 862. For example, the camera 864 can include an electronic camera or other type of image capture device. The microscope 857 further includes a stage 868 coupled to the frame 858. At least a portion of the stage 868 can be configured to move in one or more of an x-direction or y-direction relative to the frame 858.

The microscope 857 can include at least one focusing system configured to increase or decrease the distance between the at least one lens 862 and the stage 868 (e.g., a sample on the stage 868). The focusing system can be configured to at least one of move the at least one lens 862 closer to the stage 868 (e.g., incorporated into the connector 870, incorporated into the column 860) or move the stage 868 closer to the at least one lens 862 (e.g., incorporated into the stage 868). The focusing system can include any of the thermal expansion actuators disclosed herein incorporated therein.

FIGS. 8B-8D are isometric, a cross-sectional view, and enlarged cross-sectional views, respectively, of a connector 870 including a focusing system that can be used in the microscope 857 shown in FIG. 8A, according to an embodiment. The connector 870 is coupled to and is configured to move at least a portion of the column 860 relative to the frame 858. The connector 870 is configured to decrease or increase the distance between the at least one lens 862 and the stage 868. In an embodiment, the connector 870 is coupled to and configured to move the entire column 860.

Referring specifically to FIG. 8B, the connector 870 includes a first plate 872 and a second plate 874 moveably relative to the first plate 872. The first plate 872 can include any device that can be coupled to the frame 858. The first plate 872 can be coupled to the frame 858 using at least one of a mechanical fastener or an adhesive. The second plate 874 can be any device that is coupleable to and at least vertically (e.g., z-direction) moveable relative to the first plate 872. The second plate 874 can move relative to the first plate 872 when a force is exerted on the second plate 874. An example of the first and second plate 872, 874 can include the TSX-1D Fast-Drive Dovetail Stages available from Newport Corporation.

The connector 870 can further include a column securing device 876 coupled to the second plate 874. The column securing device 876 can be coupled to the second plate 874 using a mechanical fastener, an adhesive, or another suitable attachment technique. The column securing device 876 can include at least one clamp 878, or another suitable device that can couple the column 860 to the column securing device 876. The column securing device 876 can include a plate that is coupled to the second plate 874.

Referring to FIG. 8C, the connector 870 can further include a coarse actuation device 880. The coarse actuation device 880 is configured to controllably or selectively move the second plate 874 in, for example, 1 μm displacements or more relative to the first plate 872. In the illustrated embodiment, the coarse actuation device 880 includes a stationary portion 881 and a rod 882 coupled to and extending from the stationary portion 881. The stationary portion 881 is rigidly coupled to the first plate 872, the frame 858, or another suitable structure. In an embodiment, the rod 882 is configured to be controllably or selectively moved relative to stationary portion 881. The rod 882 can be threadedly coupled to the stationary portion 881 enabling the rod 882 to move relative to the stationary portion 881 when the rod 882 is rotated. The rod 882 can directly or indirectly contact the second plate 874. For example, the rod 882 can contact an apex 828 of a thermal expansion actuator 800a (FIG. 8D) that is coupled to the second plate 874. The rod 882 can move the second plate 874 upwards or downwards relative to the first plate 872 when the rod 882 correspondingly moves upwards or downwards relative to the stationary portion 881, respectively.

In an embodiment, the coarse actuation device 880 can include another device that does not include at least one of the stationary portion 881 or the rod 882. The coarse actuation device 880 can include a motor that moves the second plate 874 relative to the first plate 872. In an embodiment, the coarse actuation device 880 can be omitted.

Referring to FIG. 8D, the connector 870 can include a fine actuation device 884. The fine actuation device 884 is configured to move the second plate 874 relative to the first plate 872 in 1 μm displacements or less. The fine actuation device 884 includes a housing 886 configured to support and protect components of the fine actuation device 884. In the illustrated embodiment, the housing 886 includes a first portion 888 attached to the second plate 874 and a second portion 890 attached to and positioned vertically above the first portion 888 that at least partially encloses the components of the fine actuation device 884. In an embodiment, at least a portion of the thermal expansion actuator 800a can be electrical coupled to the first portion 888 or another component of the microscope 857 such that an electrical current can flow through at least a portion of the thermal expansion actuator 800a (e.g., cause the at least one heating element to heat the thermal expansion actuator 800a) from electrical current provided by the power source 834 (FIG. 8A). For example, the first portion 888 can include electrical conductors 895 disposed thereon that are configured to flow electrical current to and through at least a portion of the thermal expansion actuator 800a. For instance, the electrical conductors 895 on the first portion 888 can flow an electrical current from one of the support portions 804 to another of the support portions 804. In another example, the first portion 888 can include an external resistive heater (e.g., heating element 306b of FIG. 3B) attached thereto such that the external resistive heater is positioned between the first portion 888 and the thermal expansion actuator 800a or otherwise contacts the thermal expansion actuator 800a. In other embodiments, the housing 886 can include a single portion (e.g., monolithic) or include three or more portions.

The fine actuation device 884 includes the thermal expansion actuator 800a. The thermal expansion actuator 800a can include any of the thermal expansion actuators disclosed herein. For example, the thermal expansion actuator 800a can include at least one beam 802a extending between a plurality of support portions 804a and at least one heating element (not shown) configured to heat at least a portion of the thermal expansion actuator 800a.

The thermal expansion actuator 800a is rigidly secured within the housing 886 using any suitable attachment mechanism. In the illustrated embodiment, the second portion 890 of the housing 886 defines a plurality of at least partially threaded through holes 891 configured to receive threaded fasteners 892. The threaded fasteners 892 extend through the second portion 890 and press against one or more surfaces of the thermal expansion actuator 800a, thereby securing the thermal expansion actuator 800a within the housing. However, other securing devices can be used in place of the threaded fasteners 892, such as at least one pin, springs, or rivets. The fine actuation device 884 can also include a plurality of spacers 894 (e.g., washers) positioned between the threaded fasteners 892 and one or more surfaces of the thermal expansion actuator 800a. The spacers 894 can improve the contact between the threaded fasteners 892 and the thermal expansion actuator 800a. The threaded fasteners 892 or the spacers 894 can also restrict thermal expansion of the thermal expansion actuator 800a in one or more directions.

In an embodiment, the threaded fasteners 892, the spacers 894, another portion of the fine actuation device 884, the rod 882, or another portion of the microscope 857 that contacts the thermal expansion actuator 800a can be at least one of electrically or thermally insulating (e.g., made from a ceramic material) to prevent electricity or heat from the thermal expansion actuator 800a flowing therethrough and damaging or interfering with another component of the microscope 857, or causing heat losses from the thermal expansion actuator 800a.

In the illustrated embodiment, the thermal expansion actuator 800a can be controllably or selectively heated or cooled using any of the devices and/or methods disclosed herein to increase or decrease the deflection of the beam 802a. For example, an electrical current provided by the power source 834 (FIG. 8A) can be flowed through at least a portion of the thermal expansion actuator 800a from the electrical conductors 895 to heat at least a portion of the thermal expansion actuator 800a. For example, the electrical conductors 895 can be electrically conductive wire, electrically conductive tape (e.g., graphite tape, graphoil tape, or copper foil tape), or another suitable electrical contact that electrically contacts the thermal expansion actuator 800 (e.g., contacts a bottommost surface of the plurality of support portions 804). The electrical conductors 895 can be attached to, positioned on, or incorporated into the first portion 888 or another suitable location in electrical contact with the thermal expansion actuator 800a.

Deflecting the beam 802a moves the second plate 874 upwards or downwards, respectively, relative to the first plate 872. For example, when the thermal expansion actuator 800a is heated, the beam 802a increases its deflection because the threaded fasteners 892 restrict expansion of the thermal expansion actuator 800a. Similarly, when the thermal expansion actuator 800a is cooled, the beam 802a decreases its deflection. In the illustrated embodiment, an apex 428 of the beam 802a directly contacts the rod 882. Increasing the deflection of the beam 802a causes the beam 802a to press against the rod 882, thereby pushing and displacing the second plate 874 downward relative to the first plate 872. Decreasing the deflection of the beam 802a allows the second plate 874 to move upwardly relative to the first plate 872. In an embodiment, the beam 802a directly contacts another portion of the connector 870. In an embodiment, the connector 870 does not include a thermal expansion actuator and another component of the microscope 857 includes a thermal expansion actuator. In an embodiment, the connector 870 and another component of the microscope 857 both include respective thermal expansion actuators.

For example, FIG. 8E is a schematic cross-sectional view of at least a portion of a stage 868 that includes a focusing system that can be used in the microscope 857 in FIG. 8A, according to an embodiment. The stage 868 includes a thermal expansion actuator 800b that is configured to controllably and selectively move at least one component 896 of the stage 868 closer to or further from the at least one lens 862 (FIG. 8A). The thermal expansion actuator 800b can include any of the thermal expansion actuators disclosed herein. For example, the thermal expansion actuator 800b can include at least one beam 802b coupled to and extending between a plurality of support portions 804b. The thermal expansion actuator 800b can also include at least one heating element 806 configured to heat at least a portion of the thermal expansion actuator 800b. The thermal expansion actuator 800b can be restrained using any mechanism disclosed herein such that the deflection of the beam 802b increases when at least a portion of the thermal expansion actuator 800b is heated or decreases when at least a portion of the thermal expansion actuator 800b is cooled.

The at least one component 896 can include a portion of the stage 868 that supports and holds a sample. For example, the component 896 can include the entire stage 868 (except for the thermal expansion actuator 800b), one or more portions of the stage 868 that supports the sample, or the sample itself. As such, heating and cooling the thermal expansion actuator 800b can increase and decrease the distance between the stage 868 and a lens such as the at least one lens 862 shown in FIG. 8A. In an embodiment, the stage 868 can include the thermal expansion actuator 800b. In an embodiment, the stage 868 can include a coarse actuation device (not shown) that is the same as or substantially similar to the coarse actuation device 880 shown in FIGS. 8B-6D.

In an embodiment, the focusing system can be incorporated into one or more other components of the microscope 857 that are not the connector 870 or the stage 868. A focusing system including any of the thermal expansion actuators disclosed can be incorporated into the column 860. The thermal expansion actuator of the focusing system can be configured to move a portion of the column 860 that includes the at least one lens 862 relative to the rest of the column 860 (e.g., the rest of the column is fixed relative to the frame 858) such that actuating the thermal expansion actuator moves the at least one lens 862 closer to or further from the stage 868.

Referring again to FIG. 8A, the microscope 857 can include one or more sensors 840 configured to detect one or more characteristics of the microscope 857. In an embodiment, at least some sensors 840 can be at least partially disposed in, attached to, or incorporated into one or more components of the microscope 857. For example, at least one of the sensors 840 can be at least partially disposed in, attached to, or incorporated into the fine actuation device 884 (e.g., the first thermal expansion actuator 800a, the housing 886, etc.), the coarse actuation device 880, another component of the connector 870, the frame 858, the column 860, the stage 868 (e.g., the second thermal expansion actuator 800b, the component 896, etc.), or another component of the microscope 857. In an embodiment, the sensors 840 can be spaced from one or more components of the microscope 857. In an embodiment, the sensors 840 can be omitted.

In an embodiment, the sensors 840 can include at least one temperature sensor. The temperature sensor can include any of the temperature sensors disclosed. The temperature sensor can detect the temperature of the first or second thermal expansion actuators 800a, 800b, a temperature of another component of the microscope 857, or a temperature around the one or more components of the microscope 857. In an embodiment, the sensors 840 can include at least one displacement sensor. The displacement sensor can include any of the displacement sensors disclosed. The displacement sensor can detect the displacement of the first or second thermal expansion actuators 800a, 800b, the rod 882, or the distance between the at least one lens 862 and the stage 868. In an embodiment, the sensors 840 can include the camera 864. In another example, the sensors 840 can include any sensor configured to detect one or more characteristics of the microscope 857.

In an embodiment, the sensors 840 can transmit one or more sensing signals to one or more components of the microscope 857 responsive to detecting the characteristics of the microscope 857. The sensing signals can encode the detected one or more characteristics or information at least partially related to the one or more characteristics.

In an embodiment, the microscope 8575 can include a power source 834. The power source 834 can be the same as or substantially similar to the power source 134. The power source 834 can be at least one of partially disposed in, attached to, incorporated into, or space from one or more components of the microscope 857. The power source 834 is configured to provide power to one or more components of the microscope 857. For example, the power source 834 can provide power to the first or second thermal expansion actuators 800a, 800b.

In an embodiment, the microscope 857 can include a controller 836. The controller 836 can be substantially similar to or the same as controller 136 (FIG. 1D). For example, the controller 836 can be operably coupled to one or more components of the microscope 857, such as the connector 870 (e.g., the coarse actuation device 880, the fine actuation device 884), the stage 868 (e.g., the second thermal expansion actuator 800b), the power source 834, the camera 864, or another component of the microscope 857. The controller 836 can include control electrical circuitry 838 configured to control the operation of at least some components of the microscope 857 that are operably coupled to the controller 136. For example, the control electrical circuitry 838 can direct the coarse actuation device 880, the fine actuation device 884, or the second thermal expansion actuator 800b to controllably and selectively increase or decrease the distance between the at least one lens 862 and the stage 868. In an embodiment, the control electrical circuitry 838 can control the operation of one or more components of the microscope 857 responsive to the controller 836 receiving the sensing signals from the sensors 840.

The controller 836 can further include memory 846 or the memory 846 can be separate from and communicably coupled to the controller 836. The memory 846 can be configured to store one or more operational instructions or one or more sensing signals. The memory 846 can include non-transitory memory, such as random access memory (RAM), read only memory (ROM), a hard drive, a disc, flash memory, other types of memory electrical circuitry, or other suitable memory. The memory 846 can store operational instructions thereon, which can include how much power (e.g., electrical current) is required to raise the temperature of the thermal expansion actuators 800a, 800b a certain amount, the expected deflection of the thermal expansion actuators 800a, 800b after increasing or decreasing the temperature of the thermal expansion actuators 800a, 800b, when to heat the thermal expansion actuators 800a, 800b, etc. The memory 846 can also store images captured by the camera 864.

In an embodiment, the microscope 857 can include a user interface 897 configured to enable the user to direct operation of the microscope 857, such as operating the focusing system or directing the camera 864 to capture images. The user interface 897 can be configured to display information to a user (e.g., one or more images detected by the camera 864) or configured to receive instructions from the user and transmit the instructions to the controller 836. As such, the user interface 897 can include one or more of a display 898 or at least one input device 899 (e.g., a mouse, keyboard, touchscreen, etc.). For example, the at least one input device 899 can be configured to enable the user to direct operation of the microscope 857, such as operating the focusing system or directing the camera 864 to capture images. In an embodiment, the user interface 897 can be distinct from the controller 836. In such an embodiment, the user interface 897 can be communicably coupled to the controller 836 via a wired or wireless connection. In other embodiments, the controller 836 and the user interface 897 can be part of a computing device, such as a desktop computer, laptop, cellphone, tablet, etc.

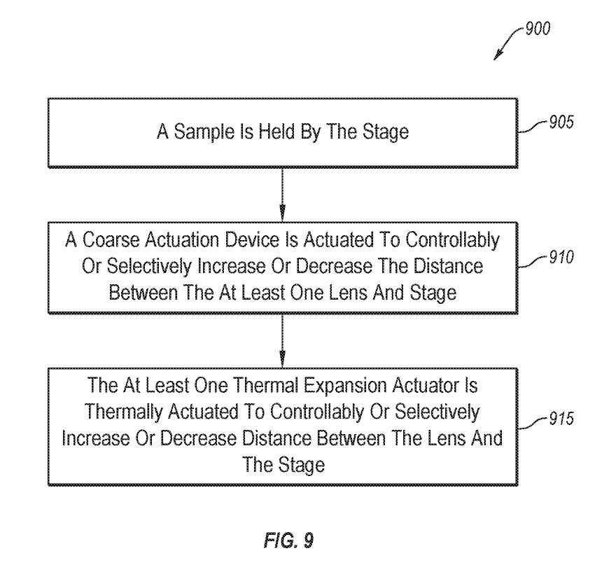

FIG. 9 is a flow diagram of a method 900 of using the microscope 857, according to an embodiment. In some embodiments, some acts of the method 900 can be split into a plurality of acts, some acts can be combined into a single act, and some acts can be omitted. Also, it is understood that additional acts can be added to method 900.

In act 905, a sample is held by the stage 868. The sample can include any of the samples disclosed. The sample can include a thick or thin malaria smear, a thick or thin borrelia smear, a thick or thin chagas disease smear, a thick or thin microfilariae smear, a blood sample configured to detect one or hematology conditions, or any other suitable sample. The sample can be held by the stage 868 by merely placing the sample on the stage 868 or securing the sample to the stage 868 (e.g., using a clamp).

In act 910, a coarse actuation device (e.g., coarse actuation device 880 of FIGS. 8B-6D) can be actuated to controllably or selectively increase or decrease the distance between the at least one lens 862 and stage 868. For example, the coarse actuation device can increase or decrease the distance between the at least one lens 862 and the stage 868 such that a portion of the sample is in focus or nearly in focus (e.g., a few micrometers, a micrometer, or less than a micrometer away from being in focus). The coarse actuation device can increase or decrease the distance between the at least one lens 862 and the stage 868 in 1 μm displacements or more. In an embodiment, the coarse actuation device (e.g., coarse actuation device 880) is operably coupled to the column 860 and configured to move the at least one lens 862 towards the stage 868. In an embodiment, the coarse actuation device is operably coupled to the stage 868 and configured to move the stage 868 towards the at least one lens 862. In an embodiment, the coarse actuation device is coupled to another component of the microscope 857 (e.g., a portion of the column 860 including the at least one lens 862).

As previously disclosed, the microscope 857 can include at least one thermal expansion actuator configured to move at least one of the at least one lens 862 closer to the stage 868 (e.g., the sample). The at least one thermal expansion actuator can include the first thermal expansion actuator 800a, the second thermal expansion actuator 800b, or another thermal expansion actuator (e.g., incorporated into the column 860). In act 915, the at least one thermal expansion actuator is thermally actuated to controllably and selectively increase or decrease the distance between the at least one lens 862 and the stage 868. For example, thermally actuating the at least one thermal expansion actuator can controllably and selectively increase or decrease the distance between the column 860 and the stage 868 in 1 μm displacements or less. The at least one thermal expansion actuator can be thermally actuated by heating or cooling at least a portion of the at least one thermal expansion actuator using any of the methods disclosed herein.

In an embodiment, the distance between the at least one lens 862 and the stage 868 can be maintained substantially the same. For example, a heating element (e.g., heating element 806 of FIG. 8E) can provide energy to the at least one thermal expansion actuator at substantially the same rate that energy leaves the at least one thermal expansion actuator.

In an embodiment, one or more sensors 840 can detect one or more characteristics of the microscope 857. The sensors 840 can detect the temperature of one or more components of the microscope 857 or around the one or more components of the microscope 857. In an embodiment, the sensors 840 can detect a displacement of at least one of the at least one lens 862, the stage 868, the rod 882, or the at least one thermal expansion actuator. The sensors 840 can create and transmit one or more sensing signals responsive to detecting the characteristics of the microscope 857.

In an embodiment, the control electrical circuitry 838 of the controller 836 can control the operation of one or more components of the microscope 857. The control electrical circuitry 838 can control the thermal actuation of act 910. In an embodiment, the control electrical circuitry 838 can control the actuation of the coarse actuation device (e.g., coarse actuation device 880 of FIGS. 8B-6D). In an embodiment, the control electrical circuitry 838 can control the operation of the one or more components of the microscope 857 responsive to receiving the sensing signals from the sensors 840.

The reader will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. The reader will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer can opt for a mainly hardware and/or firmware vehicle; alternatively, if flexibility is paramount, the implementer can opt for a mainly software implementation; or, yet again alternatively, the implementer can opt for some combination of hardware, software, and/or firmware. Hence, there are several possible vehicles by which the processes and/or devices and/or other technologies described herein can be effected, none of which is inherently superior to the other in that any vehicle to be utilized is a choice dependent upon the context in which the vehicle will be deployed and the specific concerns (e.g., speed, flexibility, or predictability) of the implementer, any of which can vary. The reader will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In an embodiment, several portions of the subject matter described herein can be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the reader will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, the various embodiments described herein can be implemented, individually and/or collectively, by various types of electro-mechanical systems having a wide range of electrical components such as hardware, software, firmware, or virtually any combination thereof; and a wide range of components that can impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electro-mechanical systems include but are not limited to a variety of consumer electrical systems, as well as other systems such as motorized transport systems, factory automation systems, security systems, and communication/computing systems. Those skilled in the art will recognize that electro-mechanical as used herein is not necessarily limited to a system that has both electrical and mechanical actuation except as context can dictate otherwise.

In a general sense, the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). The subject matter described herein can be implemented in an analog or digital fashion or some combination thereof. This disclosure has been made with reference to various example embodiments. However, those skilled in the art will recognize that changes and modifications can be made to the embodiments without departing from the scope of the present disclosure. For example, various operational steps, as well as components for carrying out operational steps, can be implemented in alternate ways depending upon the particular application or in consideration of any number of cost functions associated with the operation of the system; e.g., one or more of the steps can be deleted, modified, or combined with other steps.

Additionally, as will be appreciated by one of ordinary skill in the art, principles of the present disclosure, including components, can be reflected in a computer program product on a computer-readable storage medium having computer-readable program code means embodied in the storage medium. Any tangible, non-transitory computer-readable storage medium can be utilized, including magnetic storage devices (hard disks, floppy disks, and the like), optical storage devices (CD-ROMs, DVDs, Blu-ray discs, and the like), flash memory, and/or the like. These computer program instructions can be loaded onto a general purpose computer, special purpose computer, or other programmable data processing apparatus to produce a machine, such that the instructions that execute on the computer or other programmable data processing apparatus create a means for implementing the functions specified. These computer program instructions can also be stored in a computer-readable memory that can direct a computer or other programmable data processing apparatus to function in a particular manner, such that the instructions stored in the computer-readable memory produce an article of manufacture, including implementing means that implement the function specified. The computer program instructions can also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

In an embodiment, the printing systems disclosed herein can be integrated in such a manner that the printing systems operate as a unique system configured specifically for function of printing (e.g., three-dimensional printing), and any associated computing devices of the printing systems operate as specific use computers for purposes of the claimed system, and not general use computers. In an embodiment, at least one associated computing device of the printing systems operate as specific use computers for purposes of the claimed system, and not general use computers. In an embodiment, at least one of the associated computing devices of the printing systems are hardwired with a specific ROM to instruct the at least one computing device. In an embodiment, one of skill in the art recognizes that the printing devices and printing systems effects an improvement at least in the technological field of three-dimensional printing.

The herein described components (e.g., steps), devices, and objects and the discussion accompanying them are used as examples for the sake of conceptual clarity. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, the reader can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

In some instances, one or more components can be referred to herein as “configured to.” The reader will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications can be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, the recited operations therein can generally be performed in any order. Examples of such alternate orderings can include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, the various aspects and embodiments disclosed herein are for purposes of illustration and are not intended to be limiting, with the true scope and spirit being indicated by the following claims.

What is claimed is:

1. A thermal expansion actuator for producing relative movement between at least one lens and a stage of a microscope, the thermal expansion actuator comprising:
a plurality of support portions spaced from each other;
at least one beam generally defining a longitudinal axis and coupled to each of the plurality of support portions, at least a portion of the at least one beam is obliquely angled relative the longitudinal axis, the at least one beam including at least one slot extending at least partially therethrough; and
at least one heating element positioned and configured to heat the at least one beam.

2. The thermal expansion actuator of claim 1, wherein the at least one slot extends along at least a portion of a length of the at least one beam.

3. The thermal expansion actuator of claim 1, wherein the at least one slot includes a first slot extending from or near a first end of the at least one beam coupled to one of the plurality of support portions and a second slot extending from or near a second end of the at least one beam coupled to another one of the plurality of support portions.

4. The thermal expansion actuator of claim 1, wherein the at least one beam exhibits a length of at least 4 mm.

5. The thermal expansion actuator of claim 1, wherein the at least a portion of the at least one beam extends at an oblique angle relative to the longitudinal axis of greater than 0° and less than about 15°.

6. The thermal expansion actuator of claim 1, wherein the at least one heating element includes a coating covering one or more of at least one surface of the at least one beam or one or more of the plurality of support portions, the coating exhibiting a first electrical resistance and the at least one beam or the one or more of the plurality of support portions exhibiting a second electrical resistance that is less than the first electrical resistance.

7. The thermal expansion actuator of claim 6, wherein the coating includes anodized aluminum, and wherein the at least one beam or the one or more of the plurality of support portions includes aluminum.

8. The thermal expansion actuator of claim 1, wherein the at least one heating element is at least partially disposed in one or more of the plurality of support portions.

9. The thermal expansion actuator of claim 1, wherein the at least one heating element is at least partially disposed in the at least one beam and at least partially extends along a length of the at least one beam.

10. The thermal expansion actuator of claim 1, wherein the at least one heating element includes one or more external resistive heaters positioned and configured to heat the at least one beam.

11. The thermal expansion actuator of claim 10, wherein the one or more external resistive heaters are mounted on or near the at least one beam.

12. The thermal expansion actuator of claim 10, wherein the one or more external resistive heaters are mounted on or near one or more of the plurality of support portions.

13. The thermal expansion actuator of claim 1, further including one or more electrical wires operably coupled to the at least one heating element.

14. The thermal expansion actuator of claim 1, wherein the at least one beam includes aluminum.

15. The thermal expansion actuator of claim 1, wherein, responsive to heating by the at least one heating element, the at least one beam is configured to controllably elastically deflect, in a direction substantially perpendicular to the longitudinal axis, in 1 μm displacements or less.

16. The thermal expansion actuator of claim 1, further including one or more temperature sensors positioned and configured to sense a temperature of the at least one beam or one or more of the plurality of support portions.

17. The thermal expansion actuator of claim 16, wherein the one or more temperature sensors are mounted on at least one of the at least one beam or one or more of the plurality of support portions.

18. The thermal expansion actuator of claim 1, wherein the at least one beam includes a plurality of beams and wherein the thermal expansion actuator includes at least one shaft or plank positioned between the plurality of beams, the at least one shaft or plank coupled to at least one of the plurality of beams.

19. A microscope, comprising:
a frame;
a column coupled to the frame, the column including at least one lens;
a stage coupled to the frame and positioned below the column;
a thermal expansion actuator operably coupled to the column or to the stage, the thermal expansion actuator configured to selectively increase or decrease a distance between the at least one lens and the stage, the thermal expansion actuator including,
a plurality of support portions spaced from each other, each of the plurality of support portions coupled to one of the frame, the column, or the stage;
at least one beam coupled to the plurality of support portions, the at least one beam operably coupled to a different one of the frame, the column, or the stage than the plurality of support portions; and
at least one heating element positioned and configured to controllably heat the at least one beam; and
a controller including control electrical circuitry, the control electrical circuitry operably coupled to the at least one heating element and configured to controllably direct the at least one heating element to heat the at least one beam.

20. The microscope of claim 19, wherein the at least one beam includes at least one slot formed therein.

21. The microscope of claim 20, wherein the at least one slot extends along a length of the at least one beam.

22. The microscope of claim 20, wherein the at least one slot includes a first slot extending from or near a first end of the at least one beam coupled to one of the plurality of support portions and a second slot extending from or near a second end of the at least one beam coupled to another of the plurality of support portions.

23. The microscope of claim 19, wherein the at least one beam of the thermal expansion actuator extends at an oblique angle relative to a longitudinal axis of the at least one beam.

24. The microscope of claim 19, wherein the at least one heating element includes a coating covering at least one surface of the at least one beam or one or more of the plurality of support portions, the coating exhibiting a first electrical resistance and the at least one beam or the one or more of the plurality of support portions exhibiting a second electrical resistance that is less than the first electrical resistance.

25. The thermal expansion actuator of claim 24, wherein the coating includes anodized aluminum, and wherein the at least one beam or the one or more of the plurality of support portions includes aluminum.

26. The microscope of claim 19, wherein the at least one heating element is at least partially disposed in one or more of the plurality of support portions.

27. The microscope of claim 19, wherein the at least one heating element is disposed at least partially in the at least one beam and at least partially extends along a length of the at least one beam.

28. The microscope of claim 19, wherein the thermal expansion actuator includes one or more wires that are electrically coupled to the at least one heating element.

29. The microscope of claim 19, wherein,
the at least one heating element includes one or more external resistive heaters positioned and configured to heat the at least one beam or the plurality of support portions; and
the control electrical circuitry of the controller is operably coupled to the one or more external resistive heaters, the control electrical circuitry configured to direct operation of the one or more external resistive heaters.

30. The microscope of claim 19, wherein, responsive to heating by the at least one heating element, the at least one beam is configured to controllably elastically deflect, in a direction substantially perpendicular to a length of the at least one beam, in 1 μm displacements or less.

31. The microscope of claim 19, wherein the at least one beam exhibits a length of at least about 4 mm.

32. The microscope of claim 19, wherein the at least one beam is formed from aluminum.

33. The microscope of claim 19, further including:
one or more temperature sensors positioned and configured to sense a temperature on the at least one beam;
wherein the control electrical circuitry of the controller is operably coupled to the one or more temperature sensors, the control electrical circuitry configured to control the at least one heating element responsive to temperature sensing signals received from the one or more temperature sensors.

34. The microscope of claim 33, wherein the one or more temperature sensors are mounted to the thermal expansion actuator.

35. The microscope of claim 19, further including:
at least one displacement sensor operably coupled to the control electrical circuitry and configured to sense displacement of the at least one beam of the thermal expansion actuator;
wherein the control electrical circuitry is configured to control heat output from the at least one heating element responsive to displacement sensing signals received from the at least one displacement sensor.

36. The microscope of claim 35, wherein the at least one displacement sensor includes at least one of a magnetic displacement sensor, a capacitive displacement sensor, a piezoelectric displacement sensor, a mechanical displacement sensor, or an electro-mechanical displacement sensor.

37. The microscope of claim 19, wherein the at least one beam of the thermal expansion actuator is operably coupled to the column such that the column moves when the thermal expansion actuator is actuated.

38. The microscope of claim 19, wherein the at least one beam of the thermal expansion actuator is operably coupled to the stage such that the stage moves when the thermal expansion actuator is actuated.

39. A method of using a microscope including a frame having a column coupled thereto and a stage coupled to the frame, the column including at least one lens, the method comprising:
holding a sample on the stage of the microscope; and
thermally actuating at least one beam of a thermal expansion actuator that is coupled to the frame and operably coupled to one of the stage or the column to selectively decrease or increase a distance between the stage and the at least one lens.

40. The method of claim 39, wherein thermally actuating at least one beam of a thermal expansion actuator that is coupled to the frame and operably coupled to one of the stage or the column to selectively decrease or increase a distance between the stage and the at least one lens includes moving at least one of the stage or the column in 1 μm or less displacement.

41. The method of claim 39, wherein thermally actuating at least one beam of a thermal expansion actuator that is coupled to the frame and operably coupled to one of the stage or the column to selectively decrease or increase a distance between the stage and the at least one lens includes elastically deflecting the at least one beam of the thermal expansion actuator.

42. The method of claim 39, wherein the thermal expansion actuator includes,
a plurality of support portions that are attached to one of the frame, the stage, or the column;
at least one heating element is positioned and configured to heat the at least one beam;
wherein the at least one beam extends between the plurality of support portions.

43. The method of claim 39, wherein thermally actuating at least one beam of a thermal expansion actuator that is coupled to the frame and operably coupled to one of the stage or the column to selectively decrease or increase a distance between the stage and the at least one lens includes passing a current between at least two of a plurality of support portions.

44. The method of claim 39, wherein the at least one beam is coupled to each of a plurality of support portions and at least a portion of the at least one beam extends along a non-linear path between the plurality of support portions.

45. The method of claim 39, wherein thermally actuating at least one beam of a thermal expansion actuator that is coupled to the frame and operably coupled to one of the stage or the column to selectively decrease or increase a distance between the stage and the at least one lens includes heating the at least one beam using at least one external resistive heater.

46. The method of claim 39, further including sensing one or more characteristics of the thermal expansion actuator.

47. The method of claim 46, wherein,
sensing one or more characteristics of the thermal expansion actuator includes sensing a displacement of the at least one beam; and
thermally actuating at least one beam of a thermal expansion actuator that is coupled to the frame and one of the stage or the column to selectively decrease or increase a distance between the stage and the at least one lens occurs responsive to the sensing.

48. The method of claim 39, wherein the at least one beam exhibits a length of at least 4 mm.
